(19) United States
(12) Patent Application Publication
(10) Pub. No.: US 2018/0197160 A1
(43) Pub. Date: Jul. 12, 2018

(54) DASHBOARD PATIENT SELF SERVICE PRODUCT ENHANCEMENT

(71) Applicant: Experian Health, Inc., Franklin, TN (US)

(72) Inventors: Paul Joseph Hoffman, Mill Valley, CA (US); Jason Michael Considine, Franklin, TN (US); Michael A. Johnson, Hoquiam, WA (US); Marina Babic, Seattle, WA (US); Kevin Otto Horvath, Bloomingdale, IL (US); Anthony Causin Suralta, Puyallup, WA (US)

(73) Assignee: Experian Health, Inc., Franklin, TN (US)

(21) Appl. No.: 15/474,892

(22) Filed: Mar. 30, 2017

Related U.S. Application Data
(60) Provisional application No. 62/445,658, filed on Jan. 12, 2017.
(60) Provisional application No. 62/446,652, filed on Jan. 16, 2017.

(51) Int. Cl. G06Q 20/14; G06F 19/00

(52) U.S. Cl. CPC G06Q 20/14; G06F 19/322

(57) ABSTRACT

Aspects of methods and systems for proactively allowing the consumers to setup a transaction management plan upon determining their recovery probability are provided herein. Upon receiving an ongoing transaction record or file from a service provider, the system analyzes the ongoing transaction record or file and assigns a score based on plurality of factors such as balance on the ongoing transaction, consumer's transactional data, etc. The system further determines the consumer's recovery probability for the ongoing transaction balance. Upon determining the consumer's low recovery probability for the balance, the system sends an indication to the consumer to activate a transaction management plan or apply for assistance programs, without consumer intervention.

### CROSS-REFERENCES TO RELATED APPLICATIONS

This application claims the benefit of U.S. Provisional Application No. 62/445,658, filed Jan. 12, 2017 and U.S. Provisional Application No. 62/446,652, filed Jan. 16, 2017 which are incorporated herein in their entireties.

### BACKGROUND

Several companies allow their consumers to settle (in full or in part) bills from their websites. Oftentimes, consumers that have high balances are offered a variety of transaction management plans and/or support services to settle the balances over time or at reduced rates. Significant amounts of manual intervention are done by the companies to set up these transaction management plans or support services for consumers. Typically a consumer or an entity from an organization initiates a call to the other party to set up the transaction management plans or support services when the balances are left unsettled. Providing correct information between parties is essential to this process, and maintaining the privacy of the data shared is paramount, especially in the medical field, but is often a challenge.

### SUMMARY

Aspects of methods and systems for proactively allowing the consumers to securely set up a transaction management plan upon determining their recovery probability are provided herein. Upon receiving an ongoing transaction record from a service provider, the system analyzes the ongoing transaction record and assigns a score based on a plurality of factors such as balance on the ongoing transaction, consumer's income data, monthly bills data, etc. The system further determines the consumer's recovery probability the ongoing transaction balance. Upon determining the consumer's low recovery probability for the balance, the system securely sends an indication to the consumer to activate a transaction management plan or apply for charity care services, without consumer intervention. The accuracy and privacy of the transaction is thereby improved, and the efficiency of the transaction is further improved.

### BRIEF DESCRIPTION OF THE DRAWINGS

Further features, aspects, and advantages of the invention represented by the examples described in the present disclosure will become better understood by reference to the following detailed description, appended claims, and accompanying Figures, wherein elements are not to scale so as to more clearly show the details, wherein like reference numbers indicate like elements throughout the several views, and wherein:

FIG. 1A illustrates an example operating environment in which the various aspects of a transaction management plan advising system may be performed;

FIG. 1B is an example illustration in which the various aspects of a transaction management plan advising system may be performed;

FIGS. 2A-2V are illustrations of example user interfaces in which the various aspects of a transaction management plan advising system service may be performed;

FIG. 2W is an illustration of a flow for providing various data driven alerts by the various aspects of a transaction management plan advising system;

FIGS. 3A and 3B are flow charts showing general stages involved in example methods for the transaction management portal service;

FIG. 4 is a flow chart showing further detail general stages involved in an example method for activating a transaction management plan;

FIG. 5 is a flow chart showing further detail general stages involved in an example method for providing an estimate; and

FIG. 6 is a block diagram illustrating example physical components of a computing device with which aspects of the system may be practiced.

### DETAILED DESCRIPTION

Aspects of methods and systems for proactively allowing the consumer to set up a transaction management plan upon determining their recovery probability are provided herein. Upon receiving an ongoing transaction record from a service provider, the system analyzes the ongoing transaction record and assigns a score based on a plurality of factors such as balance on the ongoing transaction, consumer's income data, monthly bills data, etc. The system further determines the consumer's recovery probability for the ongoing transaction balance. Upon determining the consumer's low recovery probability for the balance, the system sends an indication to the consumer to activate a transaction management plan or apply for assistance programs, without consumer intervention.

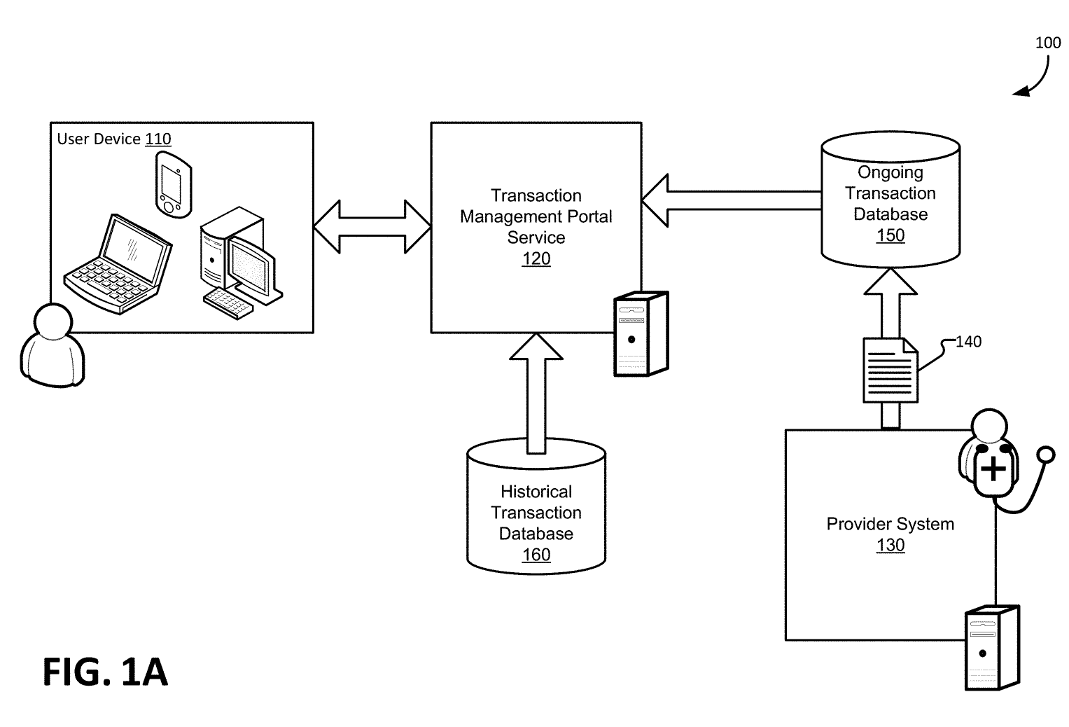

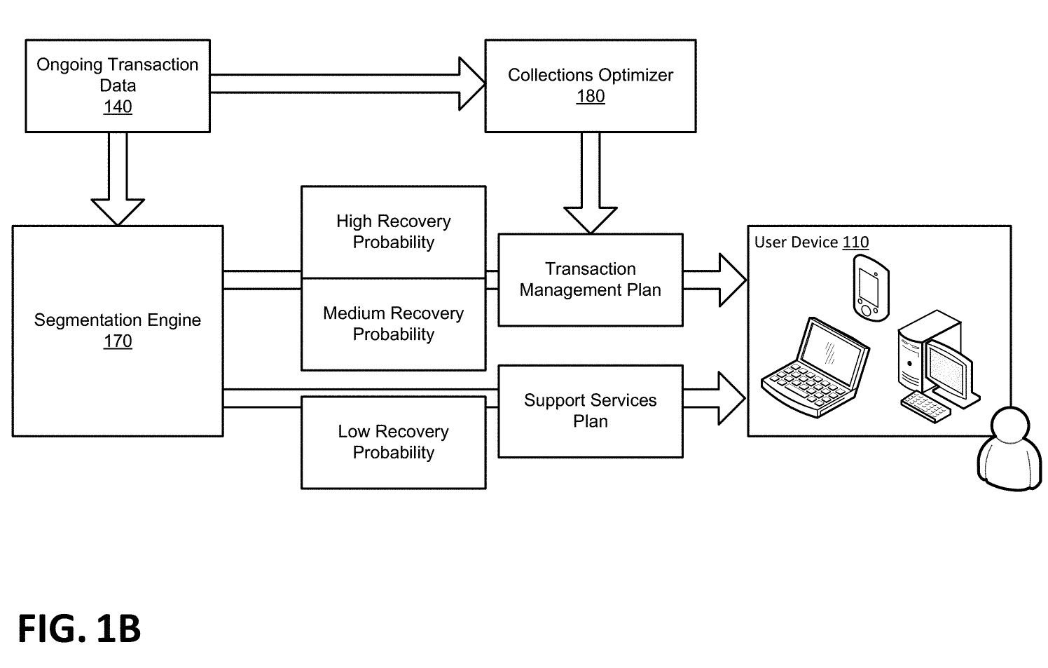

FIG. 1A illustrates an example operating environment 100 in which the various aspects of a transaction management plan advising system may be performed. As illustrated in FIG. 1A, a transaction management portal service 120 is in communication with one or more user devices 110, an ongoing transaction database 150, and a historical transactions database 160. A provider system 130 is operable to send ongoing transaction data 140 for one or more consumers to an ongoing transaction database 150 in communication with the transaction management portal service 120.

The user device 110 includes but is not limited to a mobile device, a notebook computer, a desktop computer, etc. The transaction management portal service 120 is operable to receive the ongoing transaction data 140 or aggregated ongoing transaction data 140 from several provider systems 130 and analyze them in relation to the data from the historical transactions database 160 to determine the consumer's recovery provability for the consumer's ongoing transaction balance. The transaction management portal service 120 is further operable to provide an indication to the consumer, for example, an alert on the consumer's preferred user device 110 proactively indicating the consumer to set up a transaction management plan or apply for assistance programs. The transaction management portal service 120 is also operable to provide a link to a user interface along with the alert, allowing the consumer to easily access the user interface if the consumer decides to set up the transaction management plan or apply for assistance programs.

In one aspect, in response to an indication received from the consumer to set up the transaction management plan, the transaction management portal service 120 is operable to provide a user interface to receive and store a preferred payment method and activate the transaction management plan accordingly.

In another aspect, in response to an indication received from the consumer to apply for an assistance program; the transaction management portal service 120 is operable to provide a user interface to apply for an assistance program.

In one aspect the transaction management portal service 120 is operable to receive an indication form the consumer to create an estimate for a future service, provide a user interface to receive data and calculate and provide the estimate on the dashboard for the consumer. The transaction management portal service 120 is further operable to store all of the provided estimates and provided them to the consumer upon request.

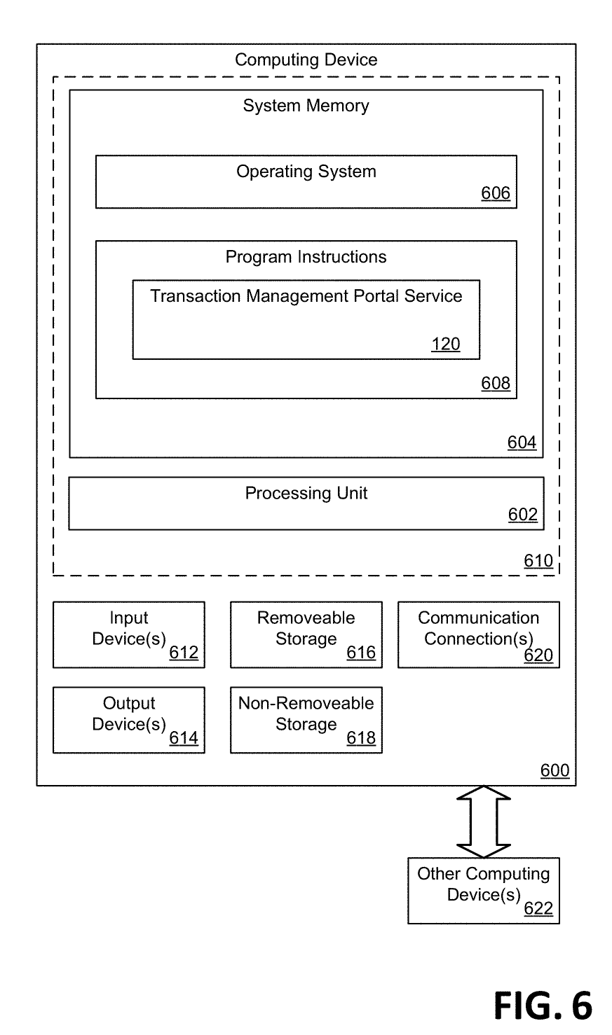

The transaction management portal service 120, the provider system 130, the ongoing transaction database 150, and the historical transactions database 160 are illustrative of a wide variety of computing devices, the hardware of which is discussed in greater detail in regard to FIG. 6. The computing devices include, but are not limited to: servers, desktop computers, laptops computers, tablets, smart phones, personal digital assistants, and distributed systems that are run on multiple computing devices. In various aspects, the transaction management portal service 120, the provider system 130, the ongoing transaction database 150, and the historical transactions database 160 are in communication with one another via the Internet, a private network, or a virtual private network or tunnel over a public network, which may include wired and wireless components to link systems that are located remotely from each other.

In various aspects the historical transaction database 160 is a computer system for a credit agency (e.g., providing credit header data for an entity's demographics), for a commercial entity (e.g. providing consumer shipping or loyalty program details for an entity's demographics), or for a governmental agency (e.g., providing official records for an entity's demographics). Although examples are given primarily in terms of human persons, it will be understood that entities include non-human persons (e.g., corporations, partnerships, agencies), animals, and inanimate objects (e.g., vehicles).

FIG. 1B is an example illustration in which the various aspects of a transaction management plan advising system may be performed. As illustrated, the ongoing transaction data 140 are received by the system and a determination about the consumer's recovery probability for the ongoing transaction balance is made. A transaction management option is proactively suggested to a high balance consumer with medium to high recovery probability, and an alert with the link to activate the transaction management plan is provided to the consumer. Similarly, an assistance program option is proactively suggested to a high balance consumer with a low recovery probability, and an alert with the link to apply for an assistance program is provided to the consumer and an immediate determination of the result of the application is also provided to the consumer applying for the assistance program.

In one aspect, the system uses a segmentation engine 170 to segment the consumers into the three categories; “consumers with high recovery probability”, “consumers with medium recovery probability”, and “consumers with low recovery probability”. The segmentation engine 170 analyses the ongoing transaction data 140 in relation with the historical transaction data for the consumers to perform the segmentation. The historical transaction data from the historical transaction database 160 are used in conjunction with the ongoing transaction data 140, to filter the consumers and segment them into qualitative brackets of consumer groups with low, medium, or high propensities to recover from. For example, consumers with credit score rating from 535 to 850, and 850+ with an ongoing transaction balances greater than $2000, are filtered as consumers with medium to high recovery probability, respectively. Further, affluent consumers with a credit score of 850 and above with an ongoing transaction balance less than $2000, are not provided with a transaction management option. As will be appreciated, these balances and score ranges are given as non-limiting examples; other ranges and balance examples are possible.

Further, as illustrated, the collections of the ongoing transactions are optimized via a collections optimizer 180 using various tools such as a propriety algorithm, data analytics, consulting input, etc. The system may apply various complex algorithms to the ongoing transaction data 140 and the historical transaction data to proactively provide consumers with tailored monthly amounts. For example, two families with identical household incomes and ongoing transaction balances may be provided with different monthly transaction management plan amounts based on their monthly bills, number of children, age of the dependents, outstanding loans, etc. In another example, an advising service is provided to the consumer via various methods of communication to provide recommendations for the monthly amounts in a transaction management plan that may fit the consumer's budget.

The high balance consumers detected by the segmentation engine 170 are engaged by providing them with appropriate alerts that suggest the high balance consumer to manage their ongoing transaction balances by either setting up transaction management plans (in case of consumers with medium through high recovery probability), or by applying for an assistance program (in case of consumers with low recovery probability). In various aspect, the consumers can be suggested the options to set up transaction management plans or apply for assistance programs via various methods of communication, such as, at the dashboard, in a statement, or via Interactive voice response (IVR) technology in a phone call, etc. In another example, the system provides an attractive transaction management plan offer and/or a discounted amount in the transaction management plan to a consumer who opts-in to receive communications from the organization. In other examples, the system provides such offers and/or discounts to the consumers via an alert on their statements or at a dashboard user interface for a transaction management plan advising system.

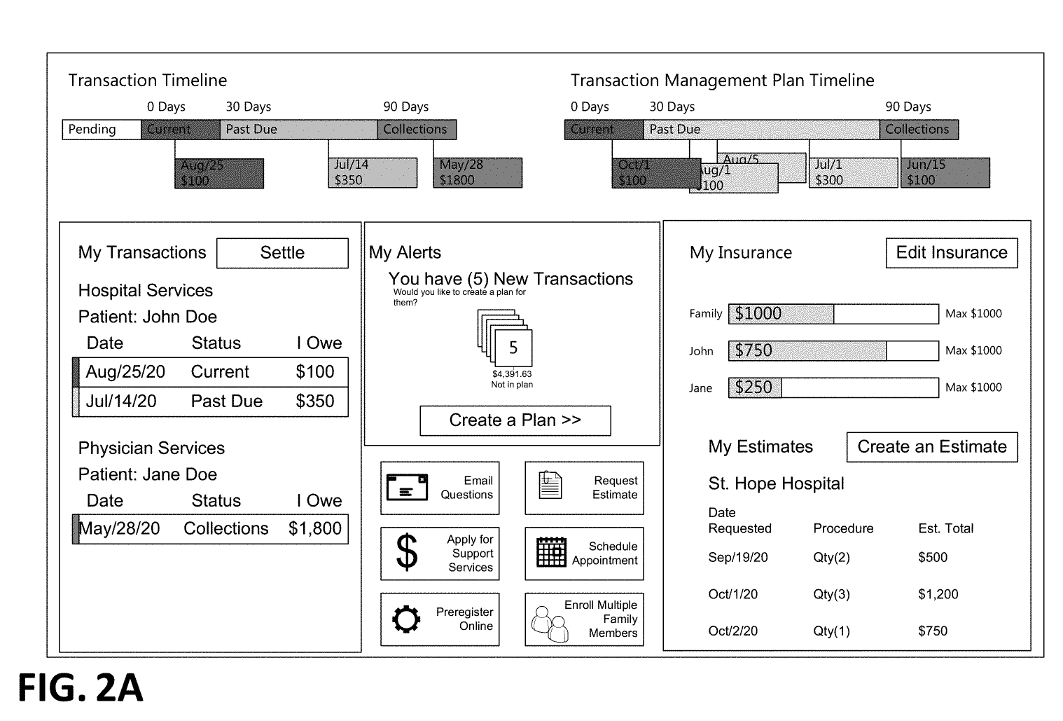

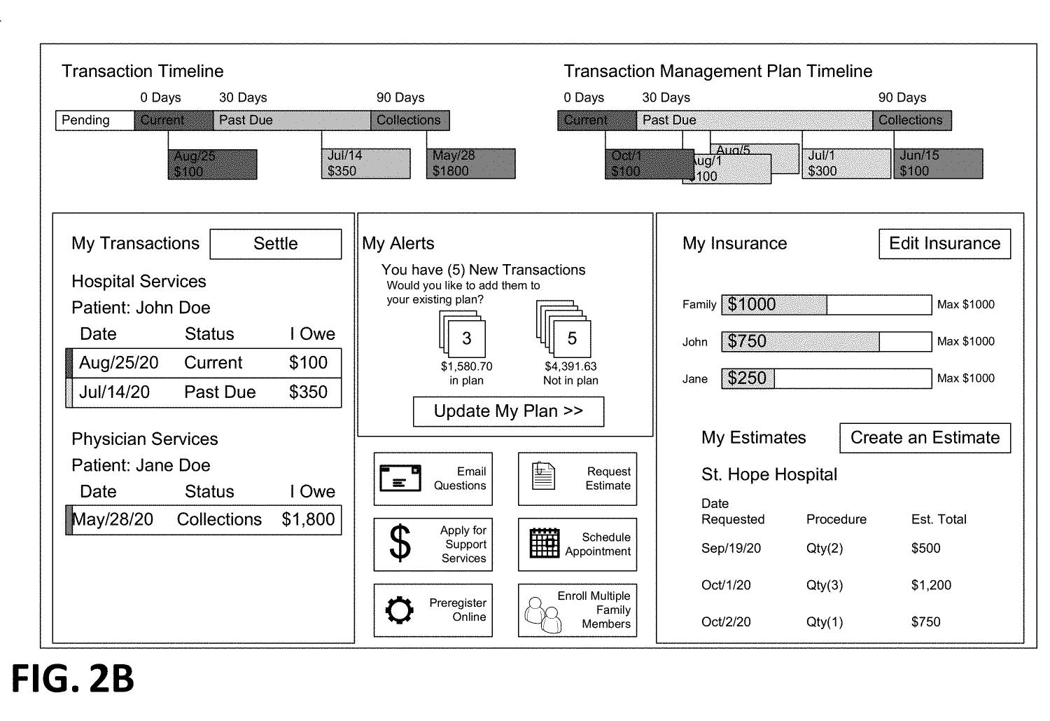

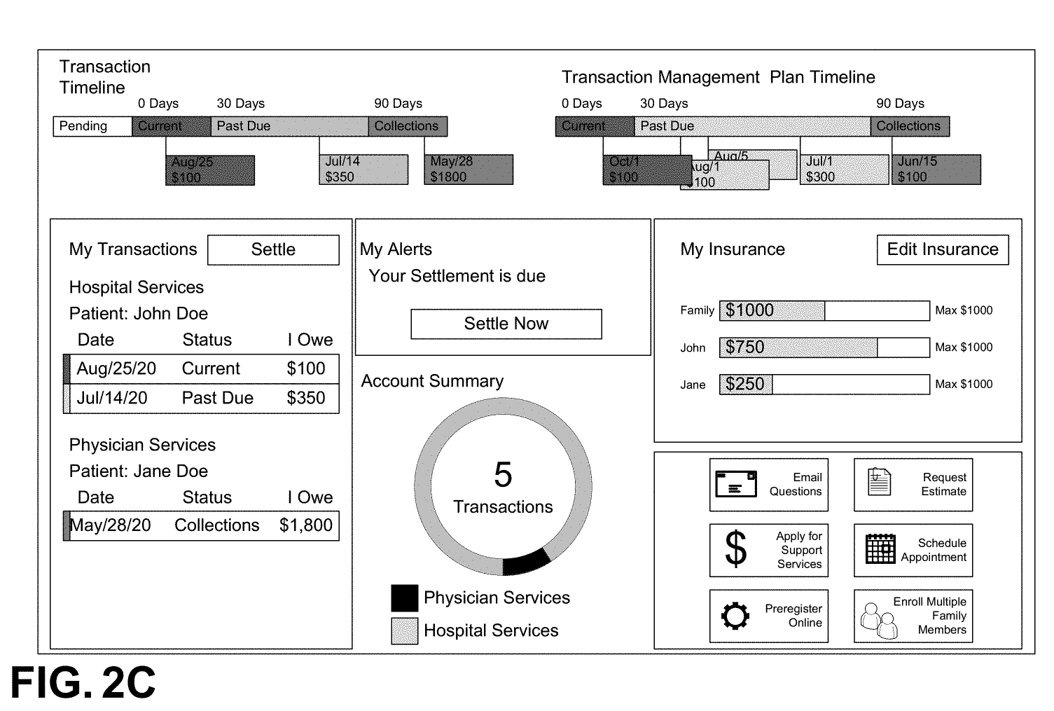

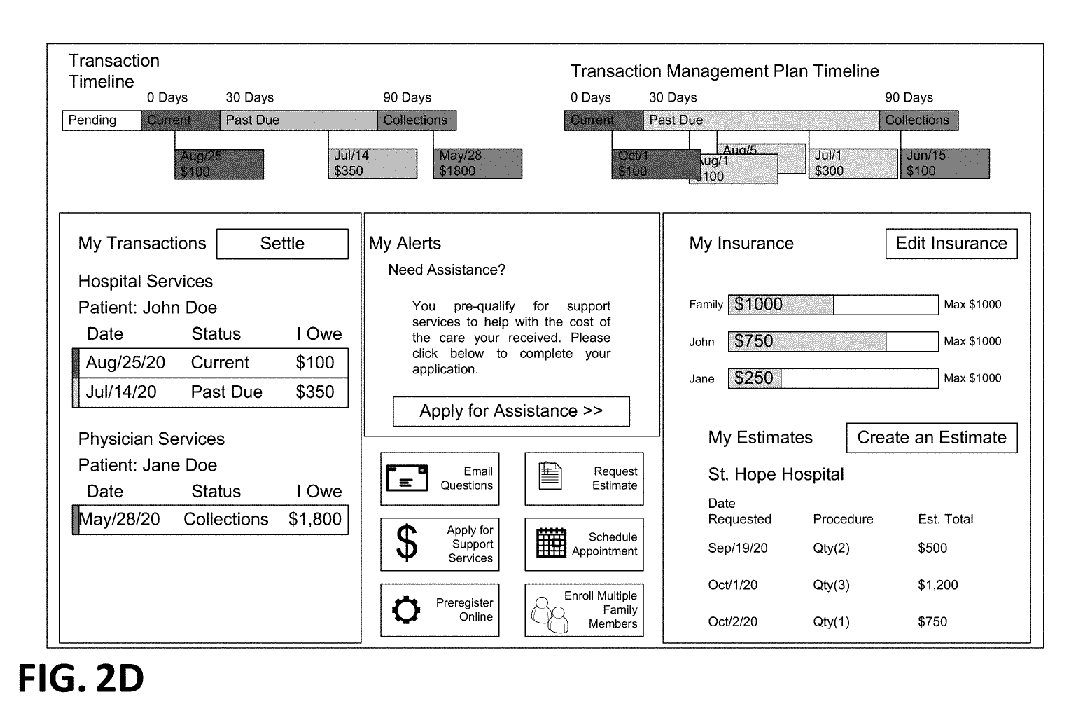

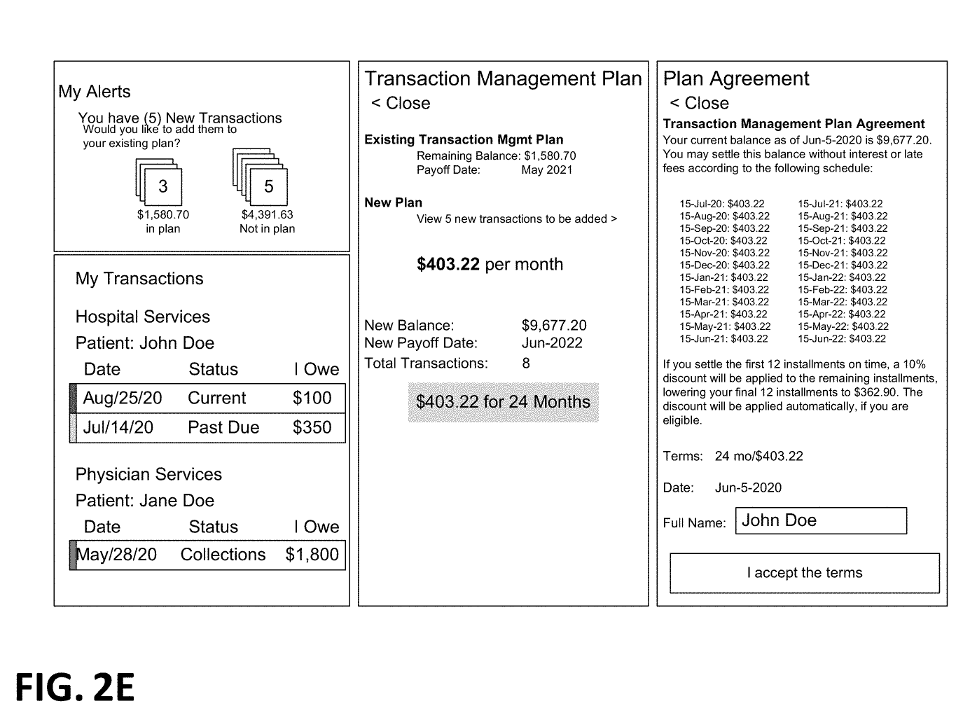

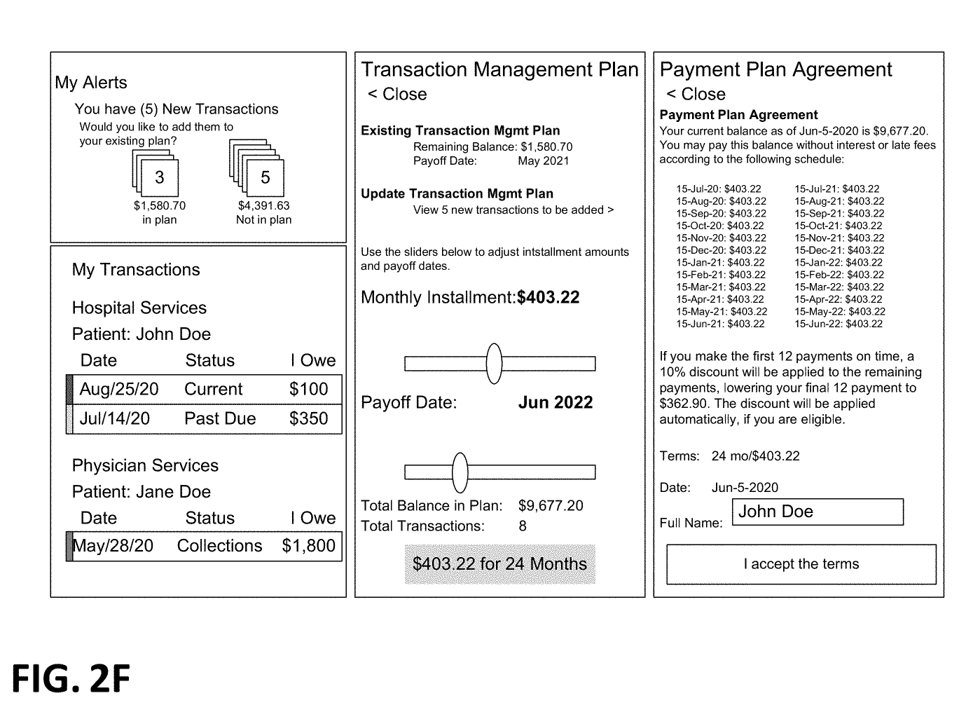

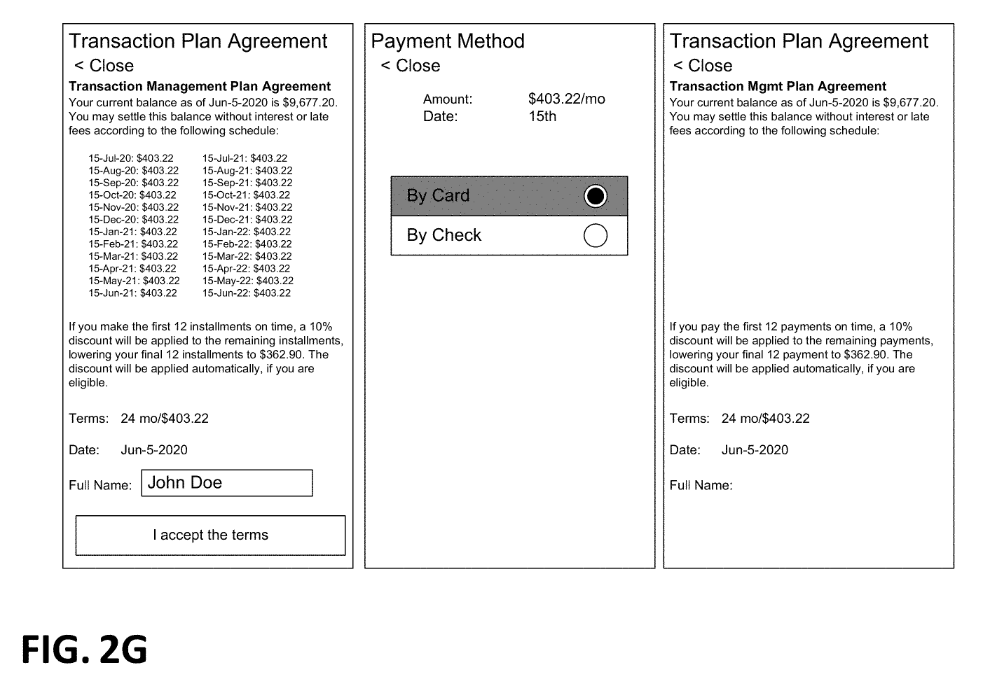

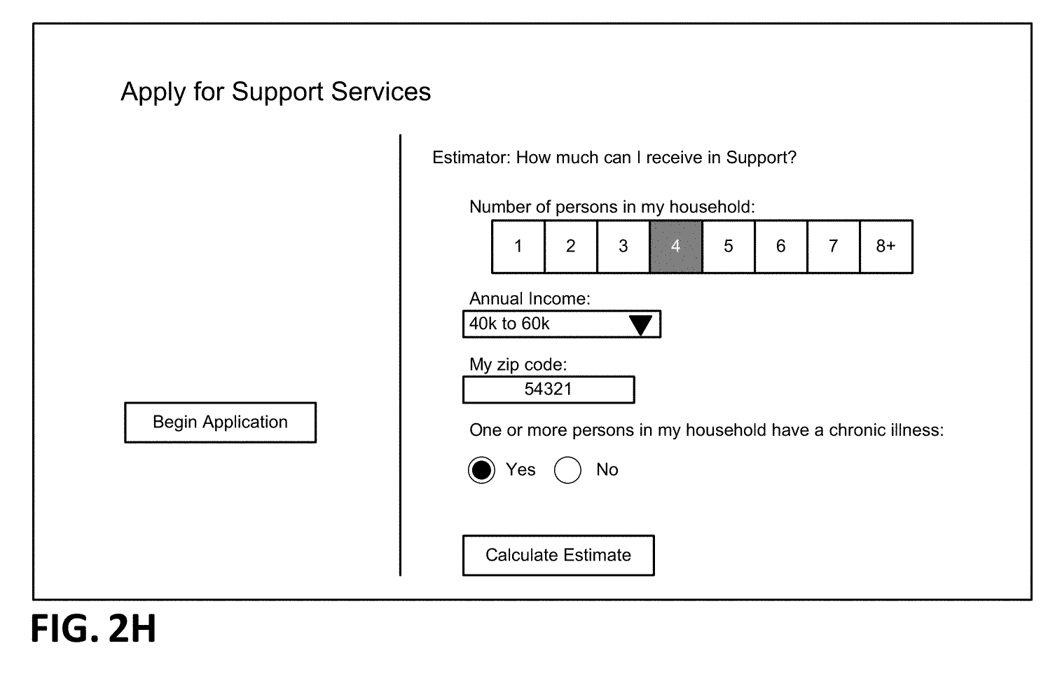

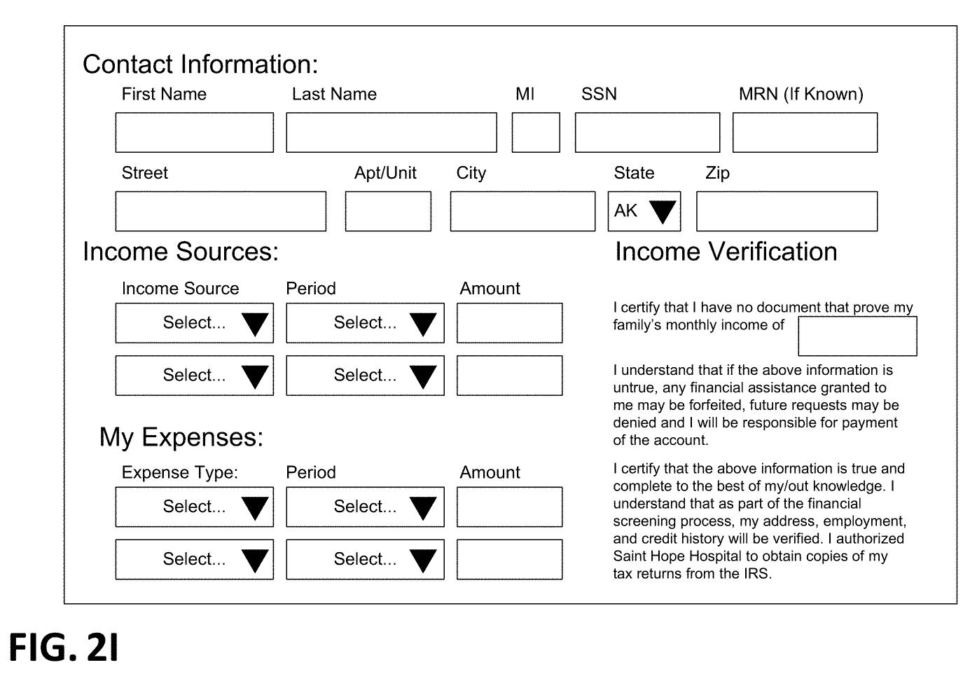

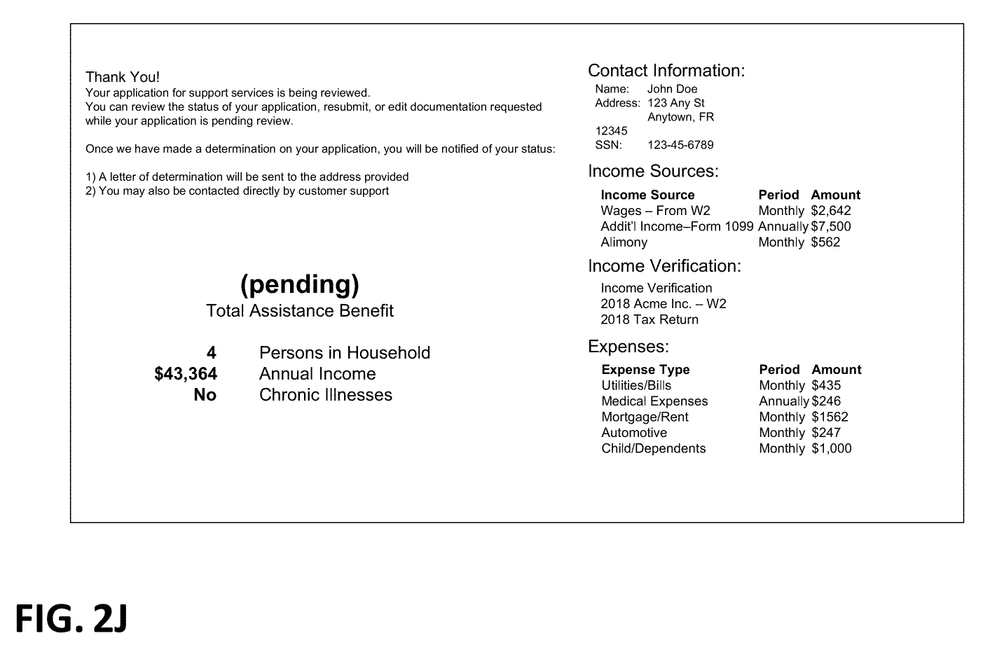

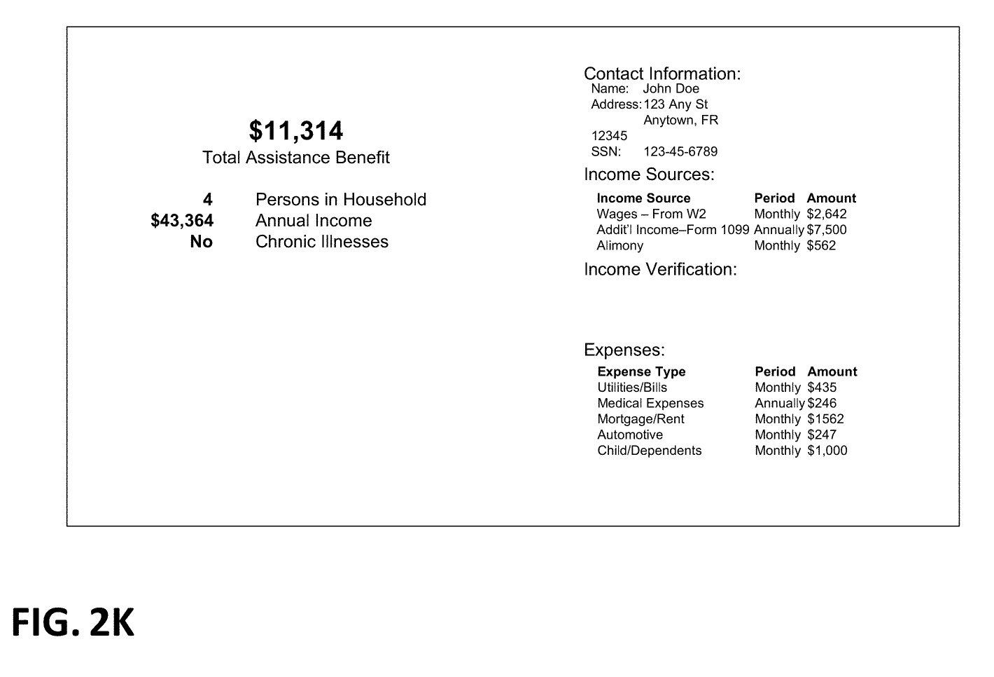

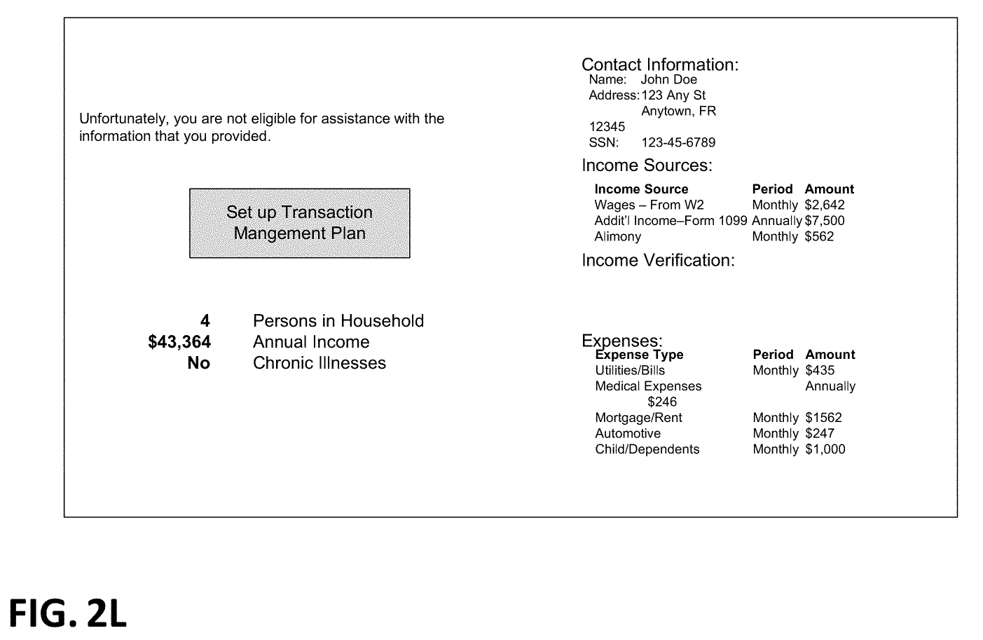

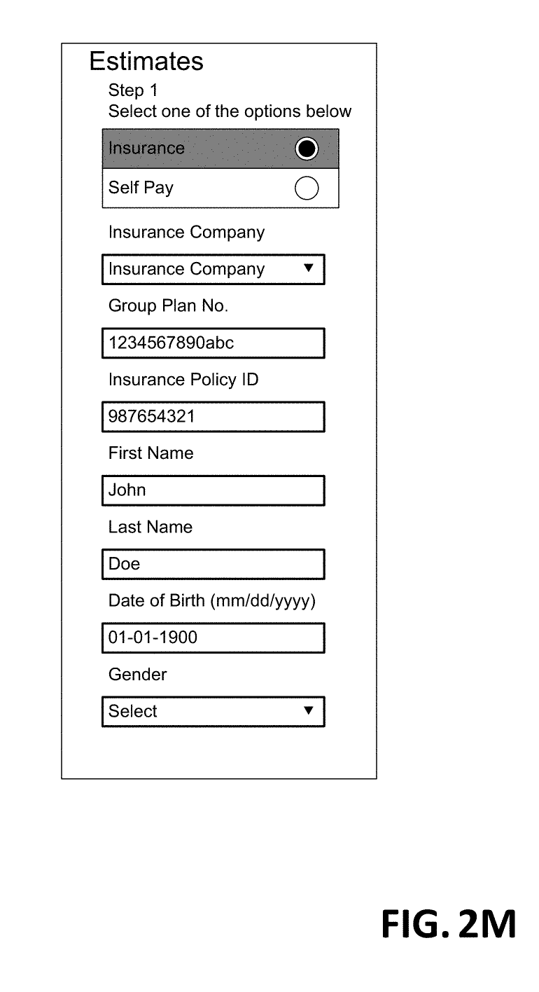

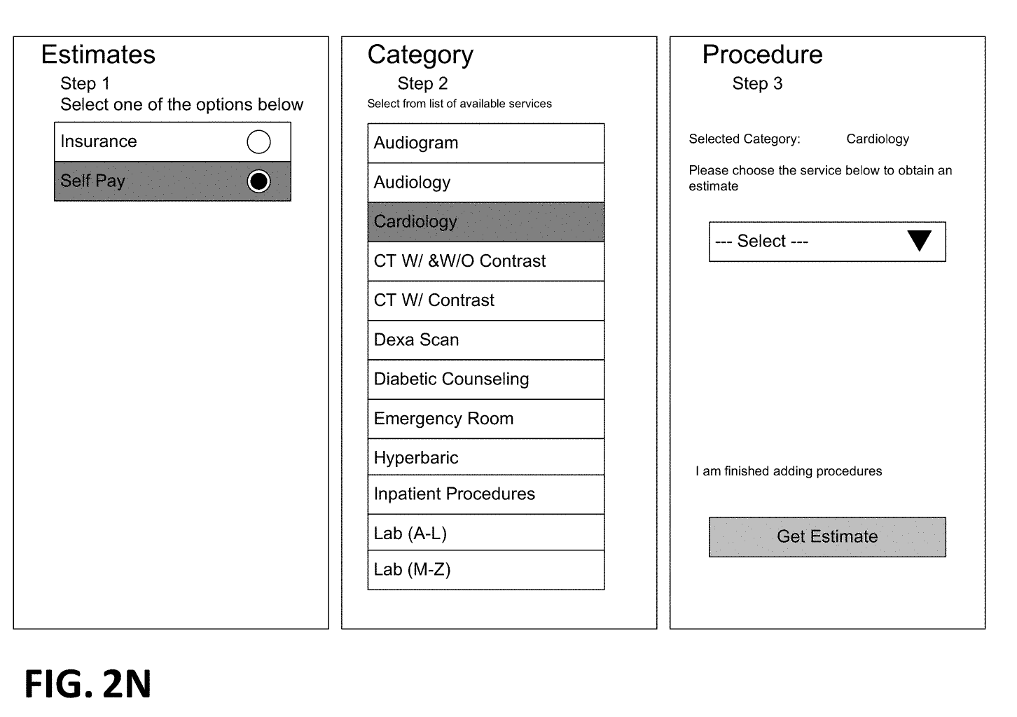

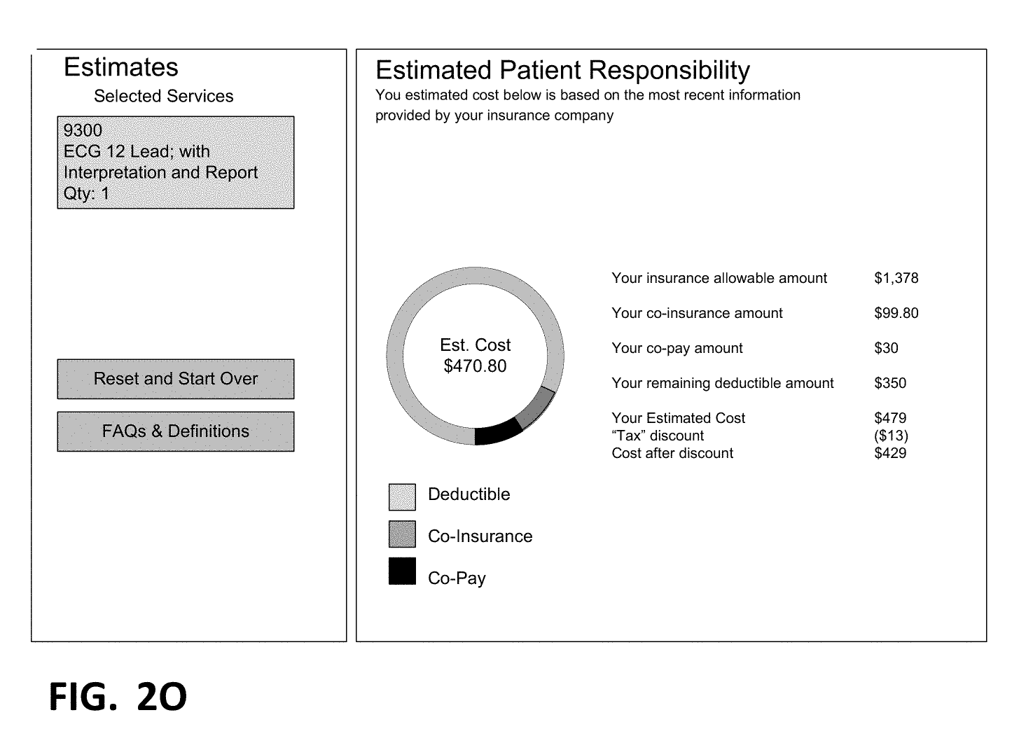

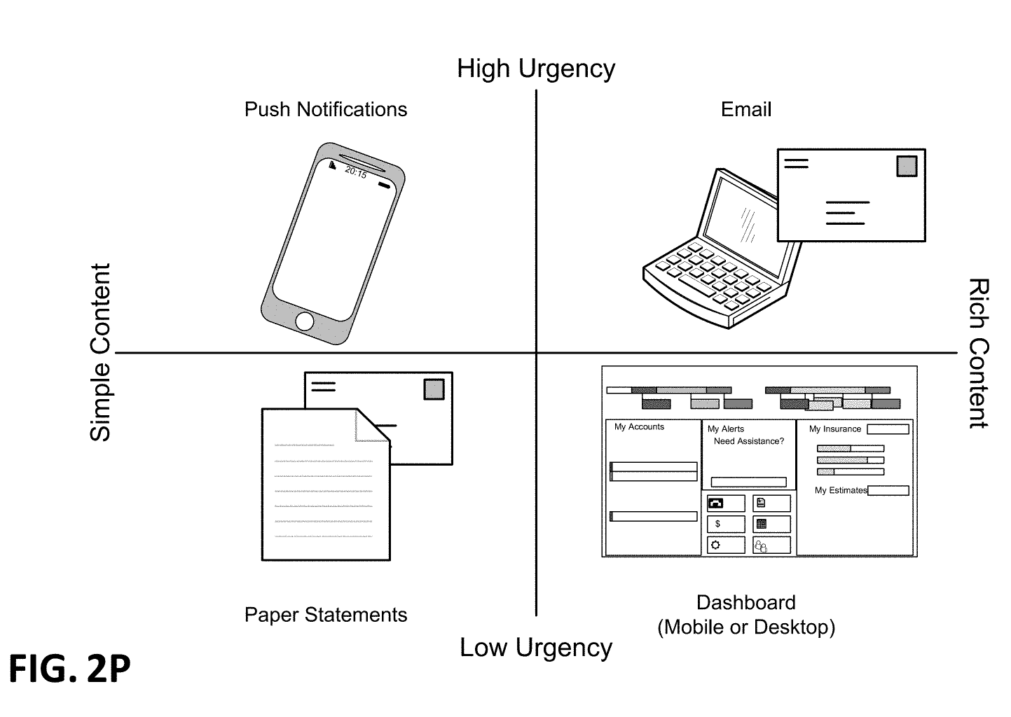

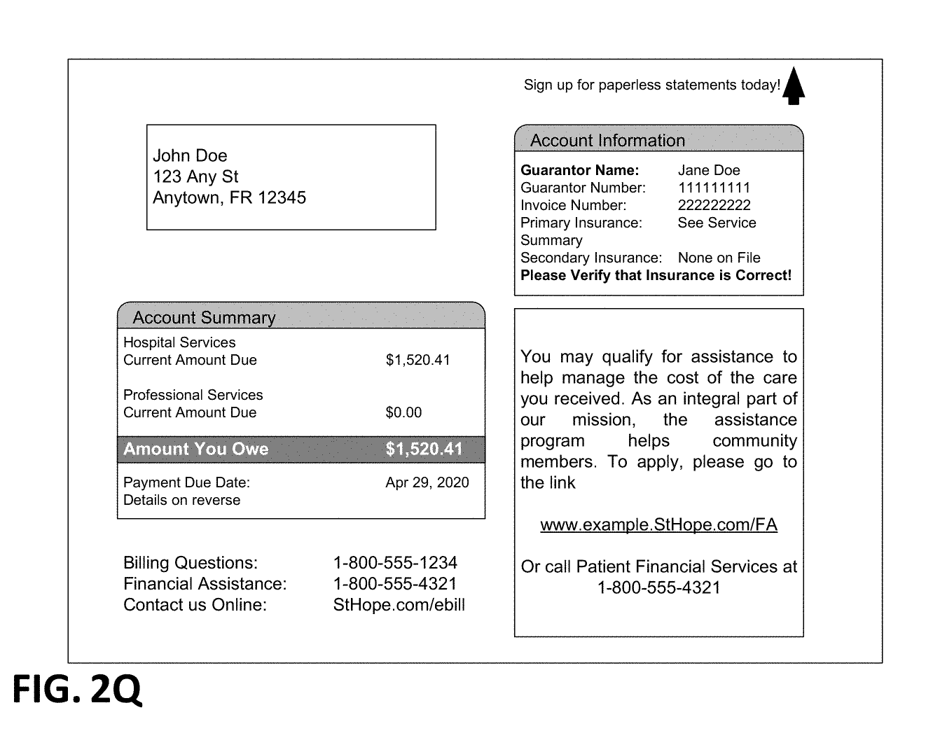

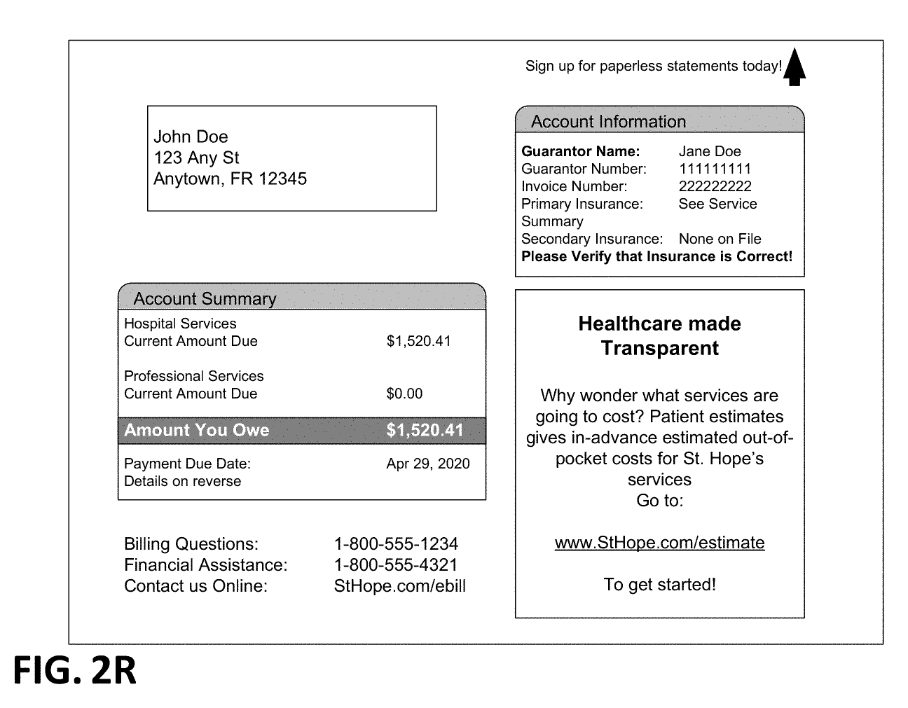

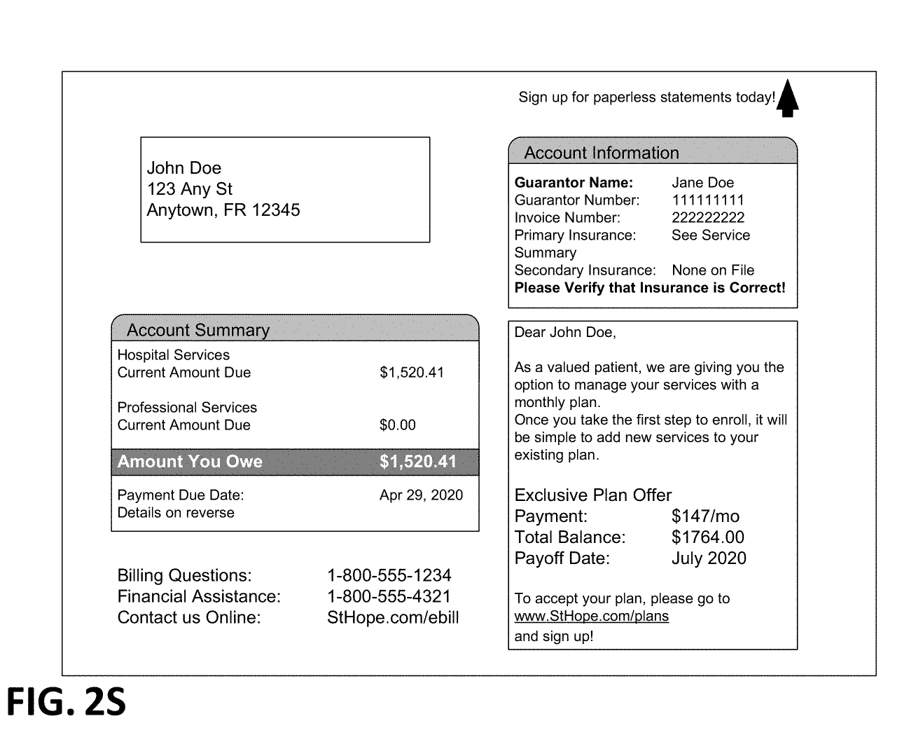

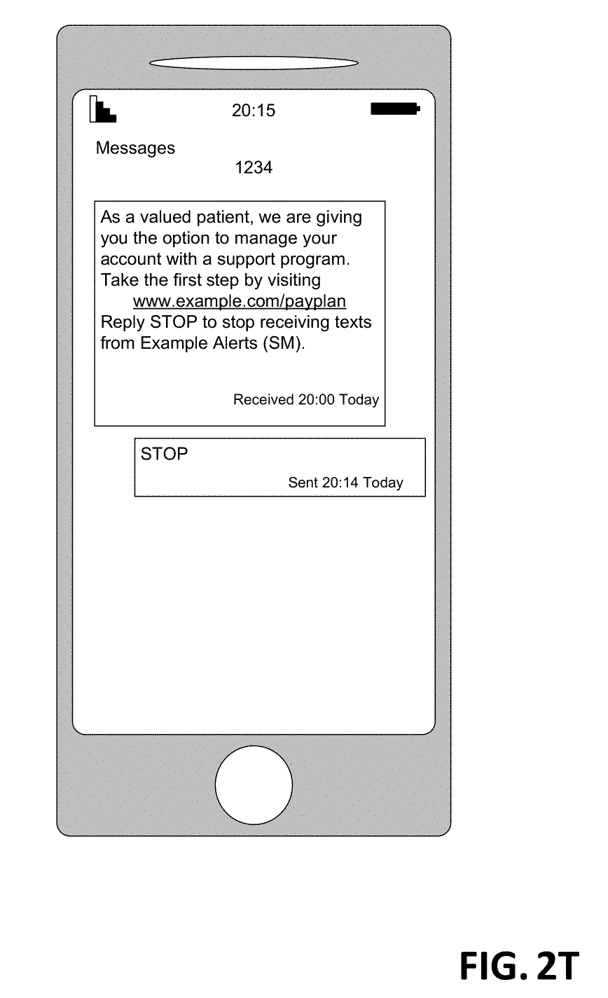

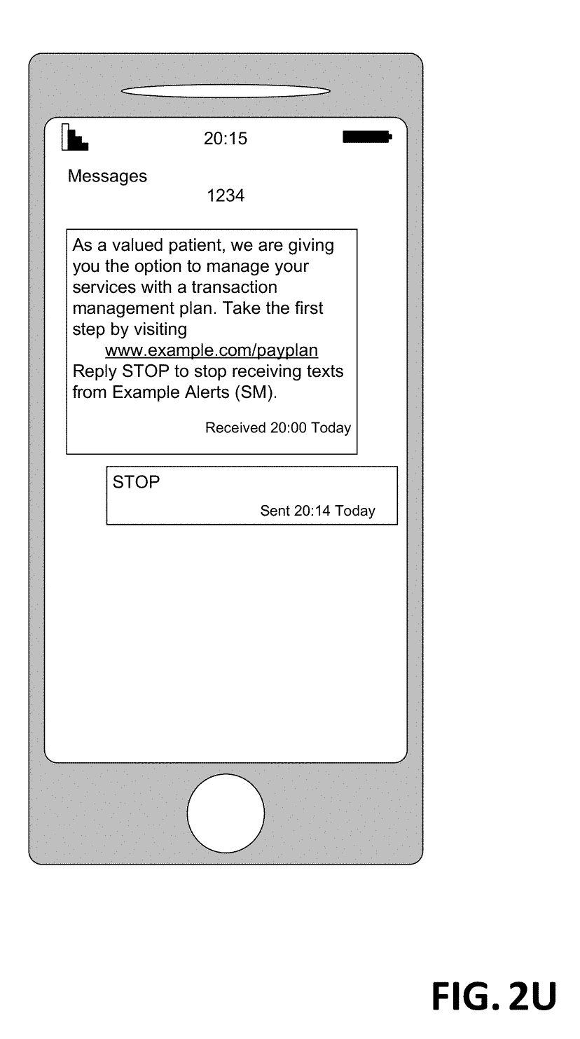

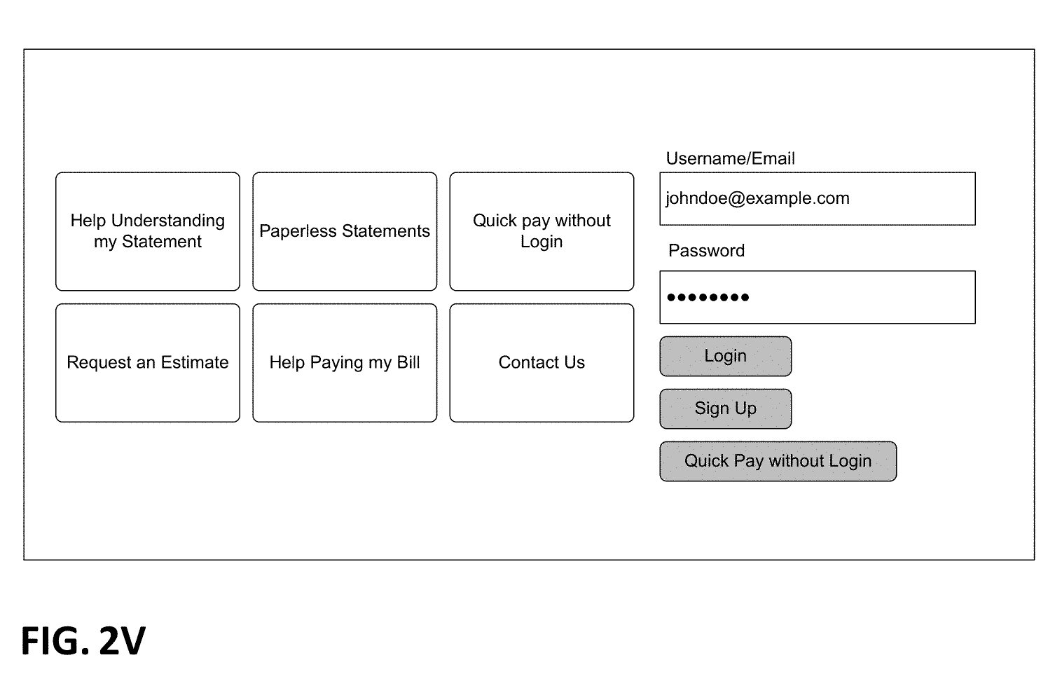

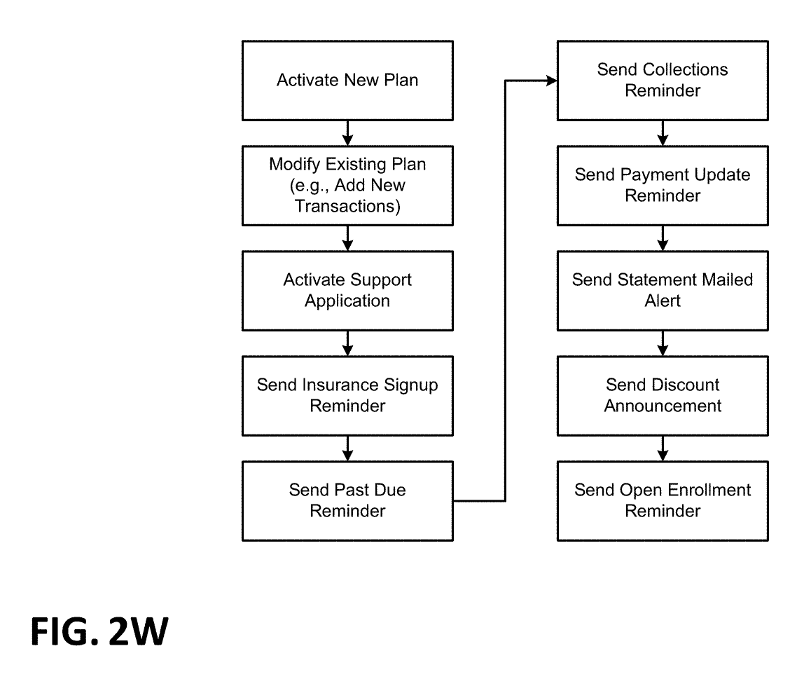

FIGS. 2A-V are illustrations of example user interfaces in which the various aspects of a transaction management plan advising system may be performed. In one aspect, as illustrated, the system provides price transparency to the consumer by allowing the consumer to enter insurance information and receive data on the current deductible and out-of-pocket amount reached for individual and family.

In various aspects, as illustrated in FIGS. 2A-D, infographics are provided to help the consumers visualize where they stand with their ongoing transactions. For example, in terms of the aging of the consumers' ongoing transactions and transaction management plans, infographics are provided on top of the main user interface, as illustrated under the “Ongoing Transaction Timeline” and “Transaction management plan Timeline” headings. For example, in terms of the aging ongoing transactions, data regarding if the ongoing transaction are “due”, “Past due”, or “Going to collections”, etc. is provided. Individual transactions or transaction management plans are shown along with their details (e.g., due dates, amounts owed, etc.). In one example, the system provides the consumers the ongoing transaction balances for all of their ongoing transaction that are severely due and with a recovery agent in the unified user interface. The system further provides the consumer with an option to settle with the provider in full or in part, or settle with the recovery agent in full or in part. This allows the consumer who may not want to contact or deal with a recovery agent to settle a balance in full from the same user interface. In one aspect, the system provides the breakdown for the amounts that are due based on the number of days past due, for example, zero to 30 days, 30 to 60 days, 60 to 90 days, and then a red bar for collections.

In another aspect, as illustrated in FIGS. 2A-B in the “My Alerts” section, infographics such as cards are provided to help the consumers visualize the number of ongoing transactions they have with one or more providers. For example, the illustrated examples show three ongoing transactions for the consumer, which have already been activated with a transaction management plan, and five ongoing transactions that are not yet set up under a transaction management plan. In another example, there may be one card deck assigned for each provider or facility for which an ongoing transaction exists for the consumer.

As illustrated in FIG. 2A, the system provides a link to the user interface to set up a transaction management plan from the main dashboard. The link allows the consumer to directly access the user interface to set up the transaction management plan, provide the preferred payment method and activate the transaction management plan easily. As can be appreciated, the system, via the dashboard, provides the consumer with accurate data about a plurality of services and ongoing transactions, personal information, performed services and procedures, estimated costs, eligibility, and schedule/performed services in one unified user interface. Ongoing transactions that have not been set up for transaction management plans may be presented in the unified interface as stacked cards representing each ongoing transaction, to convey a number of ongoing transactions associated with the consumer. Additionally, as illustrated, a number may be presented on the face of the cards to alert the consumer to the precise number of ongoing transactions. FIG. 2B illustrates a state advanced from FIG. 2A, after which several ongoing transactions have been added to transaction management plans, and are illustrated in a separate deck from unassigned ongoing transactions. The separate deck conveys the number of ongoing transactions, and relative number of plan-based ongoing transactions to plan-less ongoing transactions via two decks, which may have different “thicknesses” and number represented on their faces to indicate relative and absolute numbers of ongoing transactions.

As illustrated in FIG. 2C, the transaction management plan advising system provides the consumer with an alert for an amount due on an ongoing transaction in the unified interface and option to “pay now”, which can directly provide the consumer with a user interface to take a payment with the consumer's preferred method. As illustrated, the system provides various infographics to show the consumer the details on the aging of ongoing transactions. The system further provides the consumer with the details on the amounts covered by the insurance provider within the same user interface.

As illustrated in FIG. 2D, the system provides a link to the user interface to apply for assistance program (e.g., charity care services) from the main dashboard. The link allows the consumer to directly access the user interface to apply for an assistance program and receive an immediate response. In one example, as illustrated under the “My Insurance” heading, multiple progress bars are provided to deliver information on current deductible and out-of-pocket amounts reached. In another example, data on in-network and out-of-network deductibles and out-of-pocket amounts are also provided to the consumer. In another aspect, as illustrated under the “My Estimates” heading, the system provides price transparency to the consumer by allowing the consumer to enter data on a possible future services and receive an estimate of the probable out-of-pocket expense. In one example, the system stores all the calculated estimates to provide them to the consumer upon request in the future. The system may use an eligibility service to determine eligibility for a consumer.

In one aspect, various function keys may be provided to the consumer on the unified user interface. As illustrated, the “Emailing a question” function key allows the consumer to email a customer service representative of the organization if they have a specific question. The “request an estimate” function key provides the consumer with another user interface where data regarding a service can be entered and an estimate can be provided by the system. The “apply for an assistance program” function key provides the consumer with another user interface where an application for an assistance program can be completed. The “schedule an appointment” function key provides the consumer with the ability to schedule an appointment with the entity or facility of the consumer's choice. The “pre-register online” function key provides the consumer with the ability to pre-register for a transaction management plan or service online. The “enroll multiple family members” function key provides the consumer with a user interface to enroll multiple family members.

In another aspect, as illustrated, the system displays integrated scheduling information of the consumer's upcoming appointments (and those of members sharing an insurance policy) into the user interface under the “My Appointments” heading. This allows the consumer to have data on all past and upcoming appointments in the one unified user interface.

When the consumer accesses the personalized dashboard of the transaction management plan advising system, the system determines whether that consumer has been segmented as a consumer with high balances the recovery probability those balances (e.g., low, medium, or high). The system then automates the provision of the various tailored transaction management plan options without the consumer having to initiate such setup, by providing infographics and alerts in the dashboard to set up transaction management plans by using the available historical transaction data in conjunction with the ongoing transaction records to provide a tailored monthly transaction management plan that best fits the consumer's needs. The system continues to monitor patient behaviors and patterns and uses those behaviors to leverage multiple channels of communications such as SMS, email, etc., to send alerts to keep the consumer on-track for any ongoing transactions (e.g., to alert the consumer to set up transaction management plans or apply for an assistance program to settle the ongoing transactions), and to update the dashboard infographics to help consumers visualize the statues of their ongoing transactions (e.g., on track, due, past-due). The dashboard further aggregates the consumer's insurance data and provides the consumer with a holistic view of their insurance policies. For example, the consumer is provided with a progressive bar showing the status of the consumer's in-network and out-of-network deductibles and maximum out-of-pocket balances reached for individual and family requirements.

FIG. 2E is an illustration of an example user interface in which the transaction management plan advising system provides the consumer with the ongoing transaction records. As illustrated, the system provides the consumer with the information on the ongoing transactions that are not enrolled in a transaction management plan. The system further provides the consumer the option to add the existing ongoing transactions, not currently enrolled in a transaction management plan, into an existing transaction management plan or to a new transaction management plan. Additional details such as a transaction management plan agreement, transaction amounts, additional discount offers, etc., are also provided by the system within the same user interface. For example, as illustrated, a 10% discount is available if the first twelve payments are made on time, to encourage the consumers to make their monthly payments on time. Further, the system also provides an option to accept the offered transaction management plan within the same user interface.

FIG. 2F is an illustration of an example user interface in which the transaction management plan advising system provides the consumer with a user friendly slide bar to calculate the settlement date, if the consumer changes the monthly amount in a transaction management plan. For example, as illustrated, the slide bar corresponding to the amount of $403.22 is provided to the consumer along with a slide bar with the settlement date of April 2018, with additional details such as total balance of the transaction management plan and the number of ongoing transactions included in the transaction management plan. As the consumer slides the slide bar to the right (to increase the monthly amount in the transaction management plan), the system provides the consumer with an updated settlement date in the lower slide bar corresponding to the settlement date.

FIG. 2G is an illustration of an example user interface in which the transaction management plan advising system provides the consumer with an option to make a one-time payment with a credit card or via an electronic check. The system further provides the consumer with an option to set up automated payments via the consumer's preferred method, for the consumer's convenience.

FIG. 2H is an illustration of an example user interface in which the transaction management plan advising system implements the application for an assistance program for the consumer. As illustrated, the consumer may enter personal data such as number of people in the household, annual income, zip code, past illness, etc. to calculate an estimate of the amount of an assistance program that may be available to the consumer before beginning the application.

Upon selecting to begin application, in FIG. 2H, the consumer is provided with the user interface as illustrated in FIG. 2N, for the consumer to enter detailed information in the application.

FIGS. 2I-K are illustrations of example user interfaces provided to the consumer by the transaction management plan advising system to indicate to the consumer that the assistance program application has been received and is being reviewed. FIG. 2I illustrates the interface confirming the details submitted for requesting an assistance program. The system also provides the consumer with the option to review the status of the application, make changes, submit documentation, etc., on the same user interface. FIG. 2J indicates the benefit amount of an approved assistance program application whereas FIG. 2K indicates a rejected assistance program application. When an assistance program application is approved, as is shown in FIG. 2J, details of the assistance program are provided to the consumer in the dashboard interface (e.g., assistance amounts, assistance terms). When an assistance program application is rejected, as is shown in FIG. 2K, a link is provided in the dashboard interface for the consumer to contact the organization for alternative options. The system also provides a link to set up a transaction management plan on the same user interface for the consumer's convenience and to assist the consumer in easily setting up a transaction management plan.

FIG. 2M is an illustration of an example in which the transaction management plan advising system provides the estimates on future services. Upon selection of the link provided in the statement as shown in FIGS. 2P and 2Q, the system is operable to provide the consumer with the interface in FIG. 2M, to receive personal data and data regarding the consumer's insurance, to allow the system to provide an estimate for a future service desired by the consumer.

FIG. 2N is an illustration of an example in which the transaction management plan advising system provides the estimates on future services. The system provides the consumer with a list of categories of services to choose from, such as, for example, cardiology, inpatient procedures, etc. and then further provides an option to acknowledge the agreement and get the estimate for the future services.

FIG. 2O is an illustration of an example in which the transaction management plan advising system provides the final estimate to the consumer based on information received from user interfaces in FIGS. 2M and 2N. The system provides the consumer with an estimate comprising the insurance allowable amount, the co-insurance amount, the co-pay amount, remaining deductible, estimated cost, discounts, and net cost to the consumer after the discounts and insurance, etc. The system further provides the consumer the option to edit the insurance information, edit the coverage, recalculate estimate, view discount plans, print the estimate, contact a representative for assistance, etc.

FIG. 2P are illustrations of example user interfaces in which the various aspects of a transaction management plan advising system may be performed. In various aspects, as illustrated, the system provides alerts to the consumer based on urgency. For example, for ongoing transactions that may not be severely past due, an alert on a statement may be provided to visit the organization website and investigate the available transaction management plan options. Further, in another example, for ongoing transaction that are not severely past due, an alert is provided on the dashboard to set up a transaction management plan or apply for an assistance program.

In one example, for ongoing transactions that are severely past due, or the ongoing transactions with very high balance, the system sends an alert via a text message or an email with a link included, which allows the consumer to directly access the user interface to set up a transaction management plan or apply for an assistance program based on the consumer's recovery probability.

FIG. 2Q is an illustration of an example in which the transaction management plan advising system provides tailored communication to the consumer. As illustrated, the system provides the consumer with a message in the consumer's billing statement including a link to the website, where the consumer can apply for an assistance program to help settle the consumer's ongoing transaction balance.

FIG. 2R is an illustration of an example in which the transaction management plan advising system provides a tailored communication to a consumer in the statement. The system provides the consumer with a message on the consumer's statement with a link to indicate the consumer of the estimates service available which provides the consumer with an estimate on a service that the consumer may wish to request (but are unsure of the costs).

FIG. 2S is an illustration of an example in which the transaction management plan advising system provides a tailored communication to a consumer in the statement. The system analyzes the consumer's ongoing transaction records and based on the analysis, provides the consumer with an offer to set up a monthly transaction management plan. The system further provides the consumer with a tailored monthly amount with the additional details such as the consumer's total balance amount, etc. The system further provides the consumer with a link to the website to sign up for the transaction management plan for the consumer's convenience.

FIG. 2T is an illustration of an example in which the transaction management plan advising system provides a tailored communication to a consumer via an SMS on the consumer's mobile device. The message includes a link which the consumer may follow to directly access the user interface, right on the consumer's mobile device, to apply for an assistance program. Further, if the consumer prefers to not receive the messages, the system is operable to receive a “stop” message and update the consumer's data to include the consumer's communication preference.

FIG. 2U is an illustration of an example in which the transaction management plan advising system provides a tailored communication to a consumer via an SMS on the consumer's mobile device. The message includes a link which the consumer may follow to directly access the user interface, right on their mobile device, to set up a transaction management plan. Further, if the consumer prefers to not receive the messages, the system is operable to receive a “stop” message and update the consumer's data to include the consumer's communication preference.

FIG. 2V is an illustration of an example user interface in which the transaction management plan advising system provides the consumer with a user interface to accept the credentials to provide the consumer with the consumer's data in a dashboard. The system further provides the consumer with an option to make a quick and simple one-time payment without logging into the account, for convenience. The system also provides the consumer with other quick links to help understand the bill, request an estimate, sign up for paperless billing, sign up for an assistance program, contact customer service, request forgotten password help, etc. The user interface of FIG. 2V is provided to enable a consumer to log into the service, to create an account to access the service, or to establish/confirm a payment without logging in.

FIG. 2W is an illustration of a flow for providing various data driven alerts by the various aspects of a transaction management plan advising system. As illustrated, the alerts include alerts to activate a new transaction management plan or to modify existing transaction management plans, such as by adding new ongoing transaction records, which may be done via the user interfaces discussed above in relation to FIGS. 2A-2V or variations thereof. In one example, the system provides alerts to activate or renew a new assistance program application. The non-obligated entities that provide assistance may require the consumers to renew their applications at regular time intervals or when a major life event has occurred in the family. In another example, the system provides alerts to sign up for health insurance. For example, sometimes consumers choose to self-pay during the service, which is reflected in their ongoing transaction data received by the system. Such consumers are reminded by the system to sign up for health insurance or to provide any existing insurance details to the system that it currently lacks.

In another example, system provides alerts such as to remind the consumers that their ongoing transactions are past due, or that the ongoing transactions are moving into collections, or that a paper statement has been mailed. In one example, if a consumer's transaction management plan is set up on a credit card that may be nearing its expiration date, the system alerts the consumer to update the credit card information in the system so that the transaction management plan can continue without interruptions.

In another example, the system provides a reminder to sign up for insurance during the open enrollment period. For example, private health insurance companies or government funded programs such as Medicare oftentimes require the consumers to sign up every year or when a major life event occurs in the family. The system monitors the open enrollment periods of such companies and government programs, and alerts the consumer to sign up to prevent the consumer from missing the open enrollment deadline.

As the system receives its data from various sources in addition to the consumers' self-entry of the data, the system is configured to identify mistakes in manually entered data (e.g., a name mismatch due to a typo or undocumented name change), and is further configured to supply the user device 110 with a reduced data set when populating the various user interfaces, such as those discussed above.

Because the user device 110 is only nominally under the control of the consumer, the data sent to and accessible by the user device 110 is therefore potentially unsecured. For example, a third party (e.g., a friend, a family member, a thief) may use the consumer's user device 110 or a malicious program (e.g., a virus) may be present on the user device 110, leaving it in control of an unauthorized party. To reduce the risk of exposure of the consumer's personal and/or medical data to unauthorized parties, the system performs a majority of its calculations without user input of the variables, instead securing data (and the values of the variables) from the more highly secured ongoing transaction database 150 and historical transaction database 160 to thereby securely provide the consumer with a tailored dashboard. The consumer therefor does not need to input (and transmit) large portions of the sensitive data to the system, thereby reducing chances of its exposure.

In some aspects, to secure the data against malicious programs, the data within the dashboard are transmitted to the user device 110 as graphics (e.g., GIFs, JPGs, TIFFs, JavaScript objects, etc.) instead of text or numbers in various fields. The system formats these graphics to present the consumer with data in a format that is readable by a human, but more difficult for a computer program to extract information from. In additional aspects, the numbers and text describing procedures, ongoing transaction balances, personally identifiable information, financial data, etc. are obfuscated by the patterns and backgrounds of the dashboard elements to further confound malicious programs capable of Optical Character Recognition while leaving the data human-readable.

To prevent unauthorized human users from accessing the private data presented on the dashboard and other user interfaces discussed herein, the system is configured to require a username/password pair (or other authorization scheme) for access and is further configured to present data in a context-minimized format. For example, although the system uses the consumer's payments and/or credit history in several examples in the present disclosure, these data are not presented in the dashboard. In another example, as is shown in FIG. 2A, the amounts owed/estimated and dates are provided in the dashboard, but the names of the procedures are not. In various aspects, a consumer may follow a hyperlink (e.g., a button in the user interface) to receive greater details or add/change personally identifiable information or other private data, but may be required to re-authenticate or provide additional or alternative authentication. For example, each family member (“John Doe” and “Jane Doe” in the illustrated examples) may be able to access the dashboard user interface under a shared account, but for a procedure related to one family member, specific authorization is required (e.g., Jane is be required to input John's authorization code to see John's procedures, or John may allow his information to be seen by Jane under her authorization code but a third family member would require John's or Jane's authorization code).

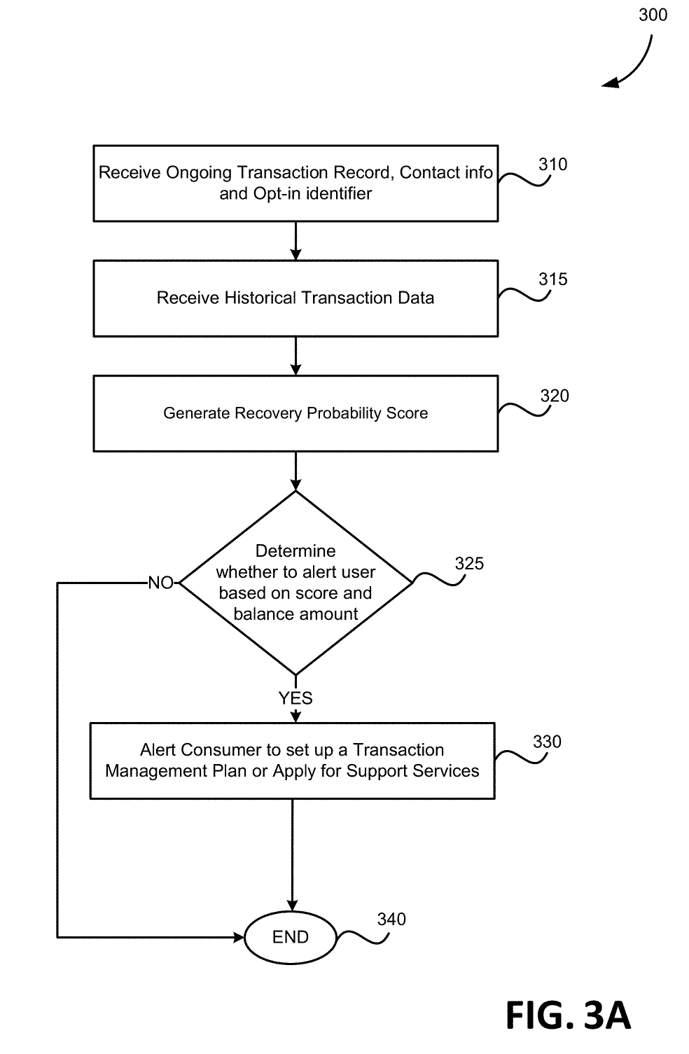

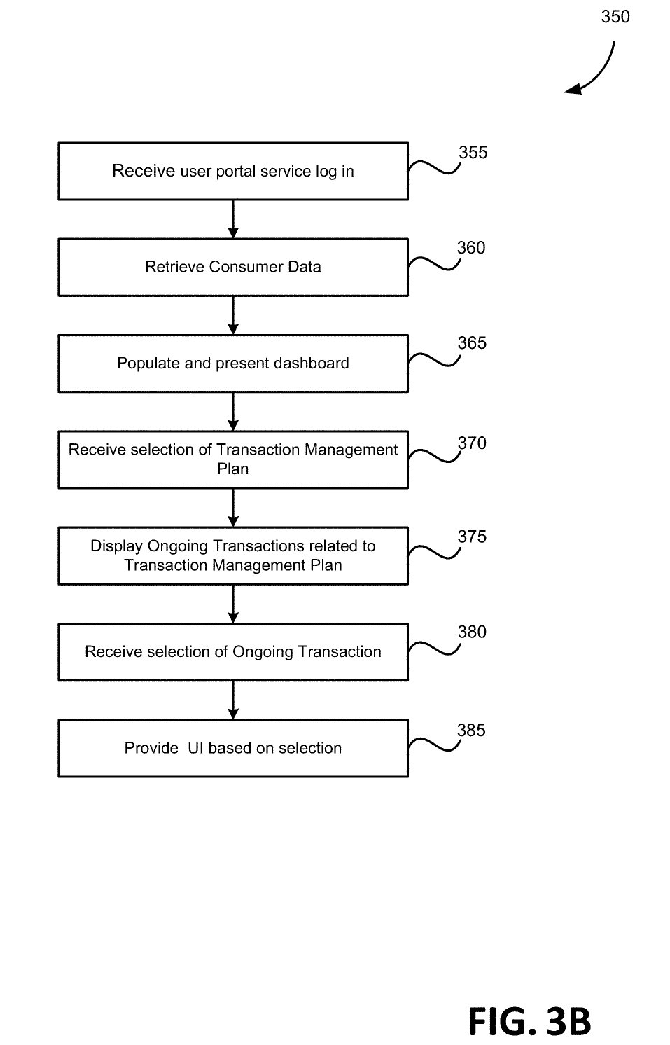

FIG. 3A is a flow chart showing general stages involved in an example method 300 for a transaction management plan advising system. Method 300 starts at OPERATION 310, where the system receives ongoing transaction data 140 including a consumer's contact information and an opt-in identifier from an ongoing transaction database 150. In one aspect, the ongoing transaction data 140 are received by the system at a pre-determined time interval, for example, daily, weekly, monthly, quarterly, semi-annually, annually, etc. In another aspect, the ongoing transaction data 140 are received by the system in real time as an update is made to the file.

The file includes the consumer's contact information, which may be received from a user device 110 at the time of signup or from the ongoing transaction database 150 based on information held by the provider system 130. In one aspect, the consumer's contact information includes the consumer's preferred method of contact. For example, if the consumer prefers to be contact via SMS or phone call, the consumer's mobile phone number is stored as the primary contact information. In another example, if the consumer prefers to be contacted by email, an email address is stored as the primary contact information. Non-primary contact information are also stored for secondary attempts to reach the consumer and for account identification or multi-factor authentication purposes. The opt-in identifier includes the information regarding whether the consumer has provided applicable permissions to be contacted regarding the transaction management plan services.

At OPERATION 315, the consumer's personal data are received by the system. According to an aspect, the consumer's personal data are maintained and stored in historical transaction database 160. The consumer's historical transaction data include previous transaction management adherence using the system, whether the consumer has been previously approved for transaction management plans or assistance programs, and other data related to the consumer, such as a credit report/score, tax records, wage records, and the like.

The system then analyzes the consumer's ongoing transaction records from the ongoing transaction data 140 in relation to the consumer's data from the historical transaction database 160 based on a plurality of factors at OPERATION 320. The factors include but are not limited to the consumer's ongoing transaction balance, income data, monthly bills data, credit score, etc. to determine the consumer's recovery probability and assign a score. In one example the assigned score is “high” indicating that a relatively higher monthly installment amount can be assigned to the consumer and is likely to be met with an acceptable risk of default or missed installments. In another example, the assigned score is “high-high” indicating that no transaction management plan is required and the consumer can afford to settle the ongoing transaction balance in full. In another example, the consumer assigned score is “medium” indicating that a relatively lower monthly installment amount can be assigned to the consumer based on the factors from the historical transaction database 160 and still expect the consumer to make the installments with an acceptable risk of default or missed installments. In another example, the consumer assigned score is “low” indicating that the lowest possible monthly installment amount should be assigned to the consumer for the settlement of the ongoing transaction balance to avoid issues, or that an assistance program determination should be made.

Method 300 proceeds to DECISION OPERATION 325, where the system determines whether to alert the consumer based on the score and the ongoing transaction balance. In one example, an organization sets an amount, such as $250, as the threshold balance amount of whether to alert a consumer. Once the consumer's balance exceeds the threshold balance amount, the ongoing transaction is considered a high balance ongoing transaction and it is determined that an alert should be generated. In various aspects, different balance thresholds may be set for different recovery probability scores, such that higher threshold is used for a consumer with a score of “high” than a consumer with a score of “low”. In various aspects, a consumer who is scored “high-high” (or similar) is determined to be able to settle the balance without need of a transaction management plan regardless of the balance amount and it is determined not to generate an alert for such a consumer.

If, at DECISION OPERATION 325, it is determined that an alert is not required to be sent to the consumer, the method 300 concludes at OPERATION 340.

If, at DECISION OPERATION 325, it is determined that an alert is required to be sent to the consumer, the method 300 proceeds to OPERATION 330, where an alert is sent to the consumer allowing the consumer to set-up a transaction management plan or apply for an assistance program. The alert is sent to the consumer's preferred method of communication. In one aspect, the alert includes a hyperlink to the user interface for setting up the transaction management plan, thus allowing the consumer to seamlessly activate the transaction management plan. In another aspect, upon determining a low recovery probability, the alert may include a link to a user interface for applying for an assistance program.

Method 300 then concludes at OPERATION 340.

FIG. 3B is a flow chart showing general stages involved in an example method 350 for the transaction management plan advising system. Method 350 starts at OPERATION 355, where the system receives a portal service login. In one aspect, the system is operable to use a single login to access all the consumer's ongoing transactions related to one or more services performed at various facilities. In various aspects, a first login may entail user interfaces for account setup, and subsequent logins may include user interfaces for account detail recovery or reset (e.g., forgotten password recovery).

Method 350 proceeds to OPERATION 360, where data associated with the consumer is retrieved by the system. The data includes, but is not limited to: the consumer's ongoing transactions, existing transaction management plans, existing assistance programs, insurance data, estimates data, services data from various facilities, ongoing transaction aging data, scheduled appointments data, etc.

At OPERATION 365, the consumer's retrieved data are populated and presented to the consumer in a unified user interface, such as a dashboard. Examples of the dashboard are presented in FIGS. 2B-V. In various aspects, to secure the data, the data are populated into graphics for inclusion in the unified user interface. These graphics include security features to provide a contextually secure human-readable presentation of the data, which minimizes unauthorized human users and malicious programs from gleaning information about the consumer. For example, text or numbers are obfuscated with a background to prevent optical character recognition or personally identifiable information is presented with an additional authentication requirement.

At OPERATION 370, a selection of a transaction management plan by the consumer is received by the system. For example, as illustrated in FIG. 2B, if the consumer desires to view or make edits to one or more of the existing three transaction management plans, the system is operable to provide the consumer with an option on the dashboard to access the existing active transaction management plans and view the details and/or make edits.

Method 350 proceeds to OPERATION 375, where the details related to the selected transaction management plan are displayed for the consumer for viewing and/or making edits. In various aspects, to secure the data, the data are populated into graphics for inclusion in the unified user interface. These graphics include security features to provide a contextually secure human-readable presentation of the data, which minimizes unauthorized human users and malicious programs from gleaning information about the consumer. For example, text or numbers are obfuscated with a background to prevent optical character recognition or personally identifiable information is presented with an additional authentication requirement.

At OPERATION 380, a selection of an ongoing transaction by the consumer is received by the system. For example, as illustrated in FIG. 2B, if the consumer desires to view or assign one or more of the five ongoing transactions that are not currently set up under a transaction management plan to a transaction management plan, the system is operable to provide the consumer with an option on the dashboard to access the ongoing transactions. The system accordingly provides a user interface for the consumer to view the details of the ongoing transactions, assign one or more ongoing transactions to existing transaction management plans, or create new transaction management plans for the selected ongoing transactions. In various aspects, the balances of the ongoing transactions are provided to the user, but the details of the ongoing transaction are kept private to the consumer for whom the account was generated. For example, if John and Jane share an insurance plan, but John is not authorized to view Jane's medical procedures, John may still include Jane's ongoing transactions in a transaction management plan, but Jane's private data related to the associated procedures are kept private from John.

Upon receiving a selection of an ongoing transaction, method 350 proceeds to OPERATION 385, where the appropriate user interface, related to the selected ongoing transaction is provided to the consumer, as mentioned with respect to OPERATION 380.

Method 350 then concludes.

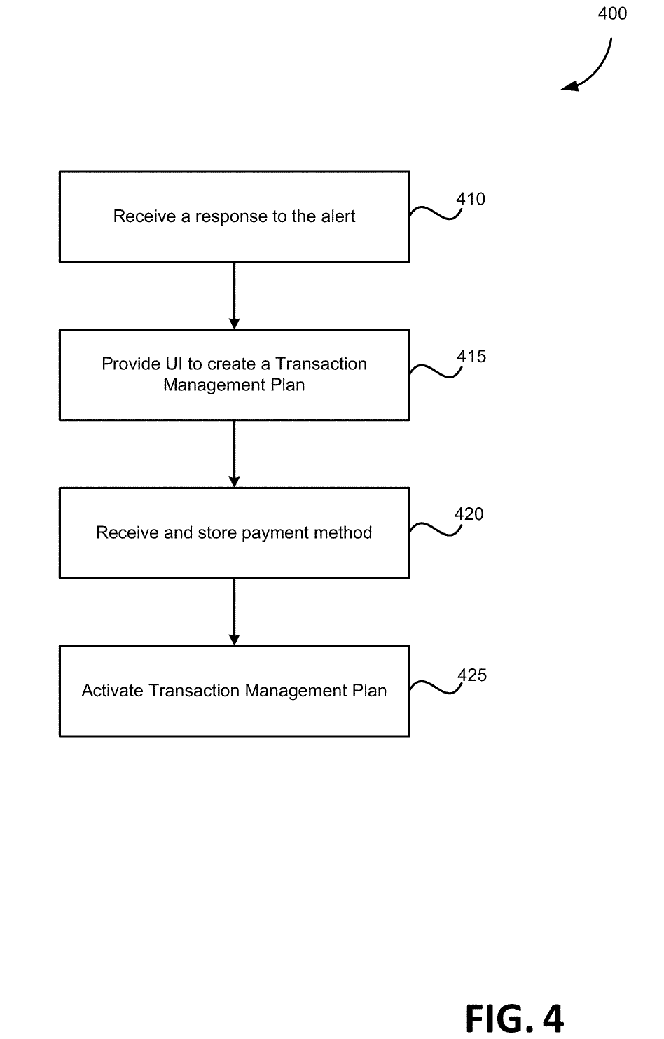

FIG. 4 is a flow chart showing further detail general stages involved in an example method 400 for activating a transaction management plan. Method 400 begins with OPERATION 410, where a response to the alert sent to the consumer at OPERATION 340 of the method 300 is received by the system. The consumer may use one of several user devices 110 (e.g., a mobile device, a desktop computer, a laptop) to respond to the alert. In some aspects, the user may be directed to log into the system with a username/password pair, or may be automatically logged into the system by another authentication scheme (e.g., an access for the system already present on the user device 110).

At OPERATION 415, a user interface to create a transaction management plan is provided to the consumer. Display of various elements in the user interface may be adjusted (shown or hidden) based on the screen size of the user device 110. The user interface is populated with data held by the system, without requiring user input from the consumer, and in various aspects the data are presented in graphics designed to secure the data from unauthorized parties.

At OPERATION 420, a consumer's preferred payment method is received and stored by the system. For example, a credit card, a bank account, guarantor or third-party payor information is received. In various aspects, these data are encrypted by the user device 110 before transmission to the system, and the system will not display these data in the user interfaces in un-obfuscated forms (e.g., only the last four digits of a credit card number, bank account, or social security number will be displayed).

At OPERATION 425, the transaction management plan is activated for the consumer by the system. The consumer may be automatically billed or manually apply finds according to the transaction management plan, and the provider to whom monies are owed credited according to the transaction management plan. Various methodologies of interest accrual and principal pay-down may be implemented to properly track payments made by the consumer over time. The consumer's ongoing transaction aging and transaction history may be displayed to the consumer via the dashboard for individual ongoing transaction as well as ongoing transaction bundled into a transaction management plan.

Method 400 then concludes.

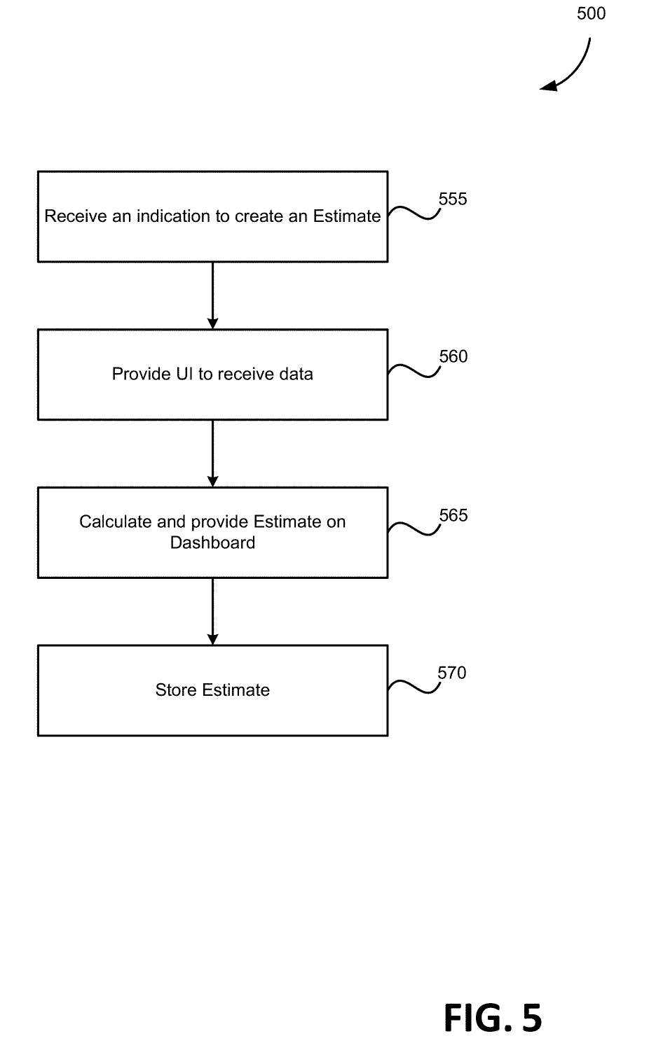

FIG. 5 is a flow chart showing general stages involved in an example method 500 for providing an estimate.

Method 500 begins at OPERATION 555, where an indication is received by the system to create an estimate for a future service.

At OPERATION 560, a user interface is provided to the consumer to receive user input regarding the details of the future service desired by the consumer. The consumer, via the user device 110, selects a desired service or services and optionally providers and/or times for those services. In various aspects, the consumer selects a specific service or group of services via a step-by-step narrowing of service types, such as, for example, an interface as is shown in FIG. 2N.

At OPERATION 565, an estimate is calculated and provided to the consumer. In one aspect, the estimate may be provided on a dashboard for the consumer, such as, for example, as is shown in FIG. 2O. In various aspects, the data provided to the user are formatted as graphics indicating the various obligations that the service impacts, such as, for example, a portion that is met by a deductible, co-insurance, and co-pay.

At OPERATION 570, the estimate is stored by the system to be provided to the consumer upon later request, such as, for example, as review or a similar request.

Method 500 then concludes.

FIG. 6 is a block diagram illustrating physical components of an example computing device with which aspects may be practiced. The computing device 600 may include at least one processing unit 602 and a system memory 604. The system memory 604 may comprise, but is not limited to, volatile (e.g. random access memory (RAM)), non-volatile (e.g. read-only memory (ROM)), flash memory, or any combination thereof. System memory 604 may include operating system 606, one or more program instructions 608, and may include sufficient computer-executable instructions for an application to enable transaction management advising system including a transaction management portal service 120, which when executed, perform functionalities as described herein. Operating system 606, for example, may be suitable for controlling the operation of computing device 600. Furthermore, aspects may be practiced in conjunction with a graphics library, other operating systems, or any other application program and is not limited to any particular application or system. This basic configuration is illustrated by those components within a dashed line 610. Computing device 600 may also include one or more input device(s) 612 (keyboard, mouse, pen, touch input device, etc.) and one or more output device(s) 614 (e.g., display, speakers, a printer, etc.).

The computing device 600 may also include additional data storage devices (removable or non-removable) such as, for example, magnetic disks, optical disks, or tape. Such additional storage is illustrated by a removable storage 616 and a non-removable storage 618. Computing device 600 may also contain a communication connection 620 that may allow computing device 600 to communicate with other computing devices 622, such as over a network in a distributed computing environment, for example, an intranet or the Internet. Communication connection 620 is one example of a communication medium, via which computer-readable transmission media (i.e., signals) may be propagated.

Programming modules, may include routines, programs, components, data structures, and other types of structures that may perform particular tasks or that may implement particular abstract data types. Moreover, aspects may be practiced with other computer system configurations, including hand-held devices, multiprocessor systems, microprocessor-based or programmable user electronics, minicomputers, mainframe computers, and the like. Aspects may also be practiced in distributed computing environments where tasks are performed by remote processing devices that are linked through a communications network. In a distributed computing environment, programming modules may be located in both local and remote memory storage devices.

Furthermore, aspects may be practiced in an electrical circuit comprising discrete electronic elements, packaged or integrated electronic chips containing logic gates, a circuit using a microprocessor, or on a single chip containing electronic elements or microprocessors (e.g., a system-on-a-chip (SoC)). Aspects may also be practiced using other technologies capable of performing logical operations such as, for example, AND, OR, and NOT, including, but not limited to, mechanical, optical, fluidic, and quantum technologies. In addition, aspects may be practiced within a general purpose computer or in any other circuits or systems.

Aspects may be implemented as a computer process (method), a computing system, or as an article of manufacture, such as a computer program product or computer-readable storage medium. The computer program product may be a computer storage medium readable by a computer system and encoding a computer program of instructions for executing a computer process. Accordingly, hardware or software (including firmware, resident software, micro-code, etc.) may provide aspects discussed herein. Aspects may take the form of a computer program product on a computer-usable or computer-readable storage medium having computer-usable or computer-readable program code embodied in the medium for use by, or in connection with, an instruction execution system.

Although aspects have been described as being associated with data stored in memory and other storage mediums, data can also be stored on or read from other types of computer-readable media, such as secondary storage devices, like hard disks, floppy disks, or a CD-ROM, or other forms of RAM or ROM. The term computer-readable storage medium refers only to devices and articles of manufacture that store data or computer-executable instructions readable by a computing device. The term computer-readable storage media does not include computer-readable transmission media.

Aspects of the present invention may be used in various distributed computing environments where tasks are performed by remote processing devices that are linked through a communications network.

Aspects of the invention may be implemented via local and remote computing and data storage systems. Such memory storage and processing units may be implemented in a computing device. Any suitable combination of hardware, software, or firmware may be used to implement the memory storage and processing unit. For example, the memory storage and processing unit may be implemented with computing device 600 or any other computing devices 622, in combination with computing device 600, wherein functionality may be brought together over a network in a distributed computing environment, for example, an intranet or the Internet, to perform the functions as described herein. The systems, devices, and processors described herein are provided as examples; however, other systems, devices, and processors may comprise the aforementioned memory storage and processing unit, consistent with the described aspects.

The description and illustration of one or more aspects provided in this application are intended to provide a thorough and complete disclosure the full scope of the subject matter to those skilled in the art and are not intended to limit or restrict the scope of the invention as claimed in any way. The aspects, examples, and details provided in this application are considered sufficient to convey possession and enable those skilled in the art to practice the best mode of the claimed invention. Descriptions of structures, resources, operations, and acts considered well-known to those skilled in the art may be brief or omitted to avoid obscuring lesser known or unique aspects of the subject matter of this application. The claimed invention should not be construed as being limited to any embodiment, aspects, example, or detail provided in this application unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently. Having been provided with the description and illustration of the present application, one skilled in the art may envision variations, modifications, and alternate embodiments falling within the spirit of the broader aspects of the general inventive concept provided in this application that do not depart from the broader scope of the present disclosure.

We claim:

1. A method for providing a transaction management portal service, comprising:
receiving ongoing transaction records related to a consumer;
receiving historical transaction records related to the consumer;
calculating, based on the ongoing transaction records and the historical transaction records, a recovery probability related to the consumer;
receiving, a request to access the transaction management portal service from a user device;
determining whether the user device is associated with the consumer;
in response to determining that the user device is associated with the consumer, tailoring a user interface to the consumer, wherein user interface features are populated into the user interface based on the recovery probability; and
transmitting the user interface to the user device.

2. The method of claim 1, wherein the recovery probability is sorted into a qualitative bracket.

3. The method of claim 2, wherein the user interface features are selected for population into the user interface based on the qualitative bracket and the ongoing transaction record.

4. The method of claim 2, further comprising:
determining, based on the qualitative bracket and the ongoing transaction record, whether to present the consumer a transaction management plan;
in response to determining to present the consumer the transaction management plan, populating the user interface with a plan control to enable the user to set up the transaction management plan.

5. The method of claim 4, further comprising:
determining whether the consumer is associated with an existing transaction management plan;
in response to determining the consumer is associated with the existing transaction management plan, populating the user interface to include an option to add the ongoing transaction record to the existing transaction management plan as the plan control; and
in response to selection of the option to add the ongoing transaction record to the existing transaction management plan, adding the ongoing transaction record to the existing transaction management plan.

6. The method of claim 2, further comprising:
determining, based on the qualitative bracket and the ongoing transaction record, whether to present the consumer a support program;
in response to determining to present the consumer the support program, populating the user interface with a support control to enable the consumer to submit an application for the support program with a non-obligatory support program entity; and
in response to a selection of the support control, transmitting the application to the non-obligatory support program entity.

7. The method of claim 6, further comprising:
in response to receiving a determination from the non-obligatory support program entity related to the application, alerting the consumer of the determination.

8. The method of claim 1, wherein the user interface elements include graphics that include data from the ongoing transaction records, wherein the graphics obfuscate the data from optical character recognition.

9. The method of claim 1, further comprising:
receiving a request for an estimate from the consumer for a future transaction; and
populating the user interface with the estimate for the future transaction to the consumer.

10. The method of claim 1, wherein determining whether the user device is associated with the consumer further comprises:
receiving a username/password pair for the consumer;
determining authorized data for the consumer.

11. The method of claim 10, wherein the authorized data for the consumer include data related to a second consumer who has authorized the consumer to view the data related to the second consumer.

12. A system for providing a transaction management portal service portal service, comprising:
a processor; and
a computer readable memory storage device including instructions, that when executed by the processor enable the system to:
receive ongoing transaction records related to a consumer;
receive historical transaction records related to the consumer;
calculate, based on the ongoing transaction records and the historical transaction records, a recovery probability related to the consumer;
receive, a request to access the transaction management portal service from a user device;
determine whether the user device is associated with the consumer;
in response to determining that the user device is associated with the consumer, tailor a user interface to the consumer, wherein user interface features are populated into the user interface based on the recovery probability; and
transmit the user interface to the user device.

13. The system of claim 12, further operable to:
determine, based on the recovery probability and the ongoing transaction record, whether to present the consumer a transaction management plan or a support program;
in response to determining to present the consumer the transaction management plan, populate the user interface with a plan control to enable the user to manage the transaction management plan; and
in response to determining to present the consumer the support program, populating the user interface with a support control to enable the consumer to submit an application for the support program with a non-obligatory support program entity.

14. The system of claim 13, further operable to:
in response to determining to present the consumer the transaction management plan, determining whether the consumer is associated with an existing transaction management plan;
in response to determining the consumer is associated with the existing transaction management plan, populating the user interface with the plan control to enable the user to manage the transaction management plan includes:
populating the user interface to include an option to add the ongoing transaction record to the existing transaction management plan as the plan control; and
in response to selection of the option to add the ongoing transaction record to the existing transaction management plan, adding the ongoing transaction record to the existing transaction management plan; and
in response to determining the consumer is not associated with the existing transaction management plan, populating the user interface with the plan control to enable the user to set up a new transaction management that includes the ongoing transaction records.

15. The system of claim 13, further operable to:
in response to a selection of the support control, transmit the application to the non-obligatory support program entity; and
in response to receiving a determination from the non-obligatory support program entity related to the application, alert the consumer of the determination.

16. The system of claim 12, further operable to:
determine key dates related to the ongoing transaction record; and
in response to a key date occurring, transmit an alert to the consumer related to the ongoing transaction record.

17. The system of claim 12, wherein the user interface elements include graphics that include data from the ongoing transaction records, wherein the graphics obfuscate the data from optical character recognition.

18. A method for providing a transaction management portal service, comprising:
receiving an ongoing transaction record associated with a consumer;
receiving historical transactions data associated with the consumer;
analyzing data from the ongoing transaction record and the historical transactions data associated with the consumer;
determining a recovery probability for the consumer;
assigning a qualitative score to the consumer related to the recovery probability;
determining, based on the qualitative score and the ongoing transaction record, whether to send an alert to the consumer to set up a transaction management plan for; and
in response to determining to send the alert to the consumer, sending the alert to the consumer to set up the transaction management plan.

19. The method of claim 18, wherein the alert is transmitted to a preferred user device associated with the consumer.

20. The method of claim 18, wherein the alert is transmitted as a text message or as an email.
